(19) United States
(12) Patent Application Publication
(10) Pub. No.: US 2025/0206538 A1
(43) Pub. Date: Jun. 26, 2025

(54) STORING AND MANUFACTURING HYDROGEN IN HORIZONTALLY DRILLED WELLS

(71) Applicant: Halliburton Energy Services, Inc., Houston, TX (US)

(72) Inventors: Ronald Bosch, Houston, TX (US); Ronald Glen Dusterhoft, Houston, TX (US); Philip D. Nguyen, Houston, TX (US)

(21) Appl. No.: 18/390,710

(22) Filed: Dec. 20, 2023

(51) Int. Cl. B65G 5/00; E21B 43/26

(52) U.S. Cl. CPC B65G 5/00; E21B 43/2605

(57) ABSTRACT

A method of constructing a storage well for an energy production system comprising determining a fractured volume of the storage well with a curved wellbore by inputting the curved wellbore path, a set of formation properties, and a fracturing operation, into a fracturing model. The curved wellbore path can promote fracture interference between fracture stresses extending from the storage wellbore path. The energy production system can inject a volume of compressed gas into the fractured volume via the storage wellbore or produce a volume of gas from the fractured volume. A design process can iterate the curved wellbore path of the storage well to create a fractured volume of the storage well greater than a threshold value.

### BACKGROUND

Large scale storage of hydrogen is a key step for a regenerative cycle comprising hydrogen utilization and regeneration. Hydrogen can be generated by chemical process and/or by electrolysis powered by a green energy source. In some scenarios, the green energy source, such as wind energy, can be utilized. Thus, an ongoing need exists for convenient and safe storage for large volumes of produced hydrogen.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a partial cross-sectional view of a hydrogen production system according to an embodiment of the disclosure.

FIG. 2A is a logical block diagram of a method suitable for implementing one or more embodiments of the disclosure.

FIG. 2B is a perspective view of a hydrogen storage system according to an embodiment of the disclosure.

FIG. 2C is a perspective view of an improved hydrogen storage system according to an embodiment of the disclosure.

FIG. 2D is a partial cross-sectional view of an improved hydrogen storage system according to an embodiment of the disclosure.

FIG. 3A is a perspective view of an injection well drilled with a horizontal sinusoidal wellbore path according to another embodiment of the disclosure.

FIG. 3B is a top view of the sinusoidal wellbore with hydraulically induced fractures extending outward in the yz-plane according to another embodiment of the disclosure.

FIG. 3C is a side view of the sinusoidal wellbore with hydraulically induced fractures extending into the vertical plane according to another embodiment of the disclosure.

FIG. 3D is a top view of the sinusoidal wellbore detailing fracture interference between fracture stages according to another embodiment of the disclosure.

FIG. 3E is a side view of the sinusoidal wellbore with hydraulically induced fractures and a production well according to another embodiment of the disclosure.

FIG. 3F is a side view of the sinusoidal wellbore with hydraulically induced fractures with two production wells according to another embodiment of the disclosure.

FIG. 4A is a perspective view of an injection wellbore with a vertical sinusoidal wellbore path according to still another embodiment of the disclosure.

FIG. 4B is a top view of the vertical sinusoidal wellbore with hydraulically induced fractures and one or more production wells according to still another embodiment of the disclosure.

FIG. 5A is a perspective view of a deviated well drilled along the y-axis with a helical wellbore path according to yet another embodiment of the disclosure.

FIG. 5B is a perspective view of the helical wellbore with hydraulically induced fractures extending outward in the horizontal plane according to yet another embodiment of the disclosure.

FIG. 5C is a perspective view of the helical wellbore with hydraulically induced fractures and at least one production well according to yet another embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Certain embodiments according to the present disclosure may be directed to systems and methods for increasing and/or improving the gas storage capacity within subterranean wells. Currently, a number of installations around the world use salt caverns or depleted oil and gas formations to store hydrogen gas and produce the same hydrogen gas from subsurface storage to run turbines, produce electricity, or for use in chemical processes. However, finding a suitable salt dome formation is location dependent and may not be available proximate to a desired location. Depleted oil and gas formations may be available (or at least more so than salt caverns), however an undesirable loss of hydrogen may occur due to leak off via the formation porosity and/or downhole chemical reactions.

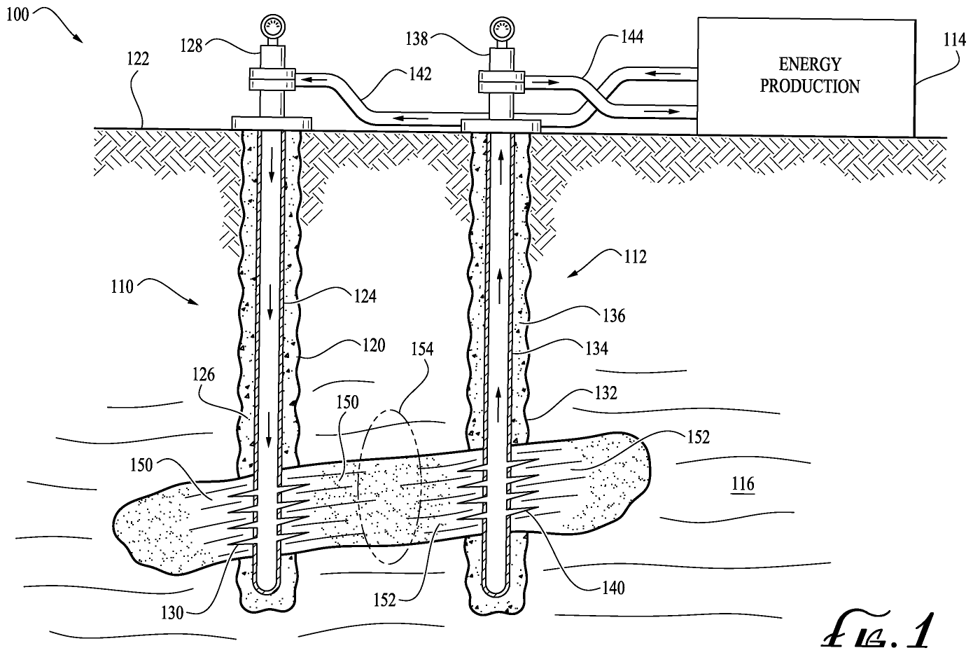

An exemplary hydrogen power and storage system 100 is illustrated in a partial cross-sectional view of FIG. 1. The hydrogen power system 100 can comprise an injection well 110, a production well 112, and a green power station 114. The injection well 110 can comprise a wellbore 120 extending from surface 122 to a porous formation 116. The wellbore 120 can be an existing wellbore or drilled with any suitable drilling system, for example, a drilling rig, a drill string with a drill bit, and a drilling fluid system. A string of casing 124 can extend from an injection wellhead 128 at surface 122 to the target depth within the porous formation 116. Cement 126 can be placed between the string of casing 124 and the wellbore 120 to form an isolation barrier and anchor the string of casing 124. The casing string 124 can be perforated 130 by any suitable means, e.g., perforation gun assembly, to fluidically couple the interior of the casing string 124 with the formation 116.

The production well 112 can be an existing well or a new wellbore. The production well 112 can comprise a wellbore 132 extending from surface 122 to the porous formation 116. A casing string 134 can extend from a production wellhead 138 at surface 122 to the target depth within the porous 116. Cement 136 can be placed between the casing string 134 and the wellbore 132 to form an isolation barrier and anchor the casing string 134. The casing string 134 can be perforated 140 by any suitable means, e.g., perforation gun assembly, to fluidically couple the interior of the casing string 134 with the formation 116.

The injection well 110 and the production well 112 can be fluidically coupled to the green power station 114 by an injection line 142 and a production line 144. The injection line 142 can deliver compressed gas, e.g., hydrogen gas, from the station 114 to the injection wellhead 128. The production line 144 can supply the station 114 with a retrieved gas, e.g., hydrogen, from the production wellhead 138. The injection line 142 can include one or more pumps suitable to provide the compressed gas at a desired flowrate and pressure value to the injection wellhead 128 and wellbore 120. The production line 144 can include one or more pumps, e.g., submersible pump, to boost or pressurize the retrieved gas at the desired pressure and flowrate.

The green power station 114 can include, for example, (i) production of electricity from renewable energy; (ii) production of hydrogen, (iii) storage of hydrogen, (iv) consumption of hydrogen, or (v) combinations thereof.

The green power station 114 can comprise a variety of renewable energy sources, for example, a wind turbine, a fuel cell, solar panels, a gas turbine (e.g., natural gas and/or hydrogen) and a generator, or combinations thereof. The wind turbine can generate electricity when wind currents are available. The solar panel, e.g., a set of solar panels, can generate electricity when solar radiation is available. Any combination of the electrical power sources can provide power for transmission via a grid or for use in local hydrogen production, consumption, or storage.

Hydrogen can be produced in the green power station 114, for example via conventional hydrogen production processes, all or a portion of which may consume electricity produced by the variety of renewable energy sources. The green power station 114 can be referred to as a gas source in response to the hydrogen production. Any combination of the electrical power sources can provide power for hydrogen production, e.g., electrolysis.

Hydrogen produced or consumed in green power station 114 can be stored underground, for example via injection well 110 and production well 112. Any combination of the electrical power sources can provide power for hydrogen storage, for example to power compressors to compress produced hydrogen for storage via injection well 110.

Hydrogen can be consumed for example in a fuel cell that can convert hydrogen (e.g., locally produced and/or stored) and/or natural gas to electricity. Additionally, or alternatively, hydrogen (e.g., locally produced and/or stored) and/or natural gas can combusted in the gas turbine to turn the generator and produce electricity. A total amount or capacity of electrical energy generated by the green power station 114 can be a function of the flowrate and pressure of the hydrogen retrieved from storage. In some embodiments, the hydrogen gas in storage can be retrieved for transport and/or industrial use, e.g., chemical processing.

In some embodiments, a hydrogen energy or power cycle comprises the generation of hydrogen gas, gas compression, and gas injection into storage with available green energy sources, e.g., wind and/or solar power. The hydrogen gas in storage can be retrieved for power generation (e.g., fuel cell or gas turbine combustion) in response to the green energy sources being unavailable, e.g., a lack of wind currents, low light conditions, darkness, etc.

The injection well 110 and production well 112 can be hydraulically fractured with a mixture of proppant, e.g., ceramic particles, and a fracturing fluid, e.g., water. The gas storage capacity can be increased and/or enhanced within the formation 116 by exposing more surface area of the reservoir and providing additional fluid pathways via fractures propped open with the proppant, e.g., ceramic particles. A network of fractures 150 may extend into the formation 116 from the injection well 110. Likewise, a network of fractures 152 may extend into the formation 116 from the production well 112. In some scenarios, the network of fractures 150 from the injection well 110 may intersect or connect within a stress interference zone 154 with the network of fractures 152 from the production well 112, however, the occurrence of the stress interference zone 154 is dependent on achieving one or more frac hits, e.g., fracture stress of a first wellbore extending to a second wellbore. A method of increasing and optimizing the stress interference zone 154 is desirable.

In some scenarios, an available volume or potential gas capacity of a depleted oil and gas reservoir may be limited by the shape of the reservoir, the caprock, reservoir fluids, or combinations thereof. A bell shape can be an ideal shape for the reservoir to be conducive for gas storage. The bell shape or similar cylinder shape can be described as a gas cavern with a sand or similar permeable material along the bottom. However, the permeable material along the bottom or fluidically connected to the sides of the bell shape can limit the pressure of the gas in storage and thus, the volume of gas in storage. In some scenarios, the caprock, e.g., impermeable formation, above the depleted reservoir may not be entirely impermeable and may leak gas pressure via one or more porous pathways. In some scenarios, the reservoir fluids within the depleted reservoir may be a mixture of water, hydrocarbons, acid, completion fluids, or combinations thereof. The existing reservoir fluid may react with hydrogen gas to form one or more undesirable compounds, e.g., methane, that results in a decrease in hydrogen gas storage capacity. The creation of a subterranean gas storage location is desirable.

A darcy unit (D), a millidarcy (mD), a microdarcy (uD), and nanodarcy (nD) are units of permeability to describe the ability of fluids to flow through porous media, e.g., rock. The darcy unit is dimensionless and defined using Darcy's law. For example, a porous structure, e.g., porous medium, with a permeability of 1 darcy permits a flowrate of 1 cubic centimeter per second (cm³/s) of a fluid with viscosity of 1 centipoise (cP) under a pressure gradient of 1 atmosphere per centimeter (atm/cm) acting across an area of 1 square centimeter (cm²). Typical values of permeability range from about 100,000 D for gravel, about 1 D for sand, less than about .01 mD for granite, or in a range from 0.01 mD to 0.1 nD, alternatively from about 10 uD to about 0.1 nD, alternatively from about 1 uD to about 1 nD, or alternatively from about 1 uD to about 0.1 nD for tight shale formations.

In an aspect, the subterranean formation 116 is a tight formation. In an aspect, the tight formation has a permeability of less than or equal to about 0.0001, 0.1, 3, or 10 microDarcy (μD), a porosity of less than or equal to about 2, 4, or 6%, or a combination thereof. In an aspect, the subterranean formation 116 is a non-permeable formation (e.g., a non-permeable, tight formation), has a porosity of less than or equal to about 2, 4, or 6%, or a combination thereof. As used herein, the term non-permeable formation will refer to a subterranean formation 116 with a permeability of less than 10 μD, alternatively of less than 3 μD, alternatively in a range of equal to or less than 0.1 mD to about 0.1 nD, alternatively in a range of equal to or less than about 10 μD to about 0.1 nD, alternatively in a range of equal to or less than about 10 μD to about 0.01 nD, alternatively in a range of equal to or less than about 3 D to about 0.01 nD, or alternatively in a range of equal to or less than about 3 μD to about 0.1 nD, for example, as found in granite or tight shale formations.

In some embodiments, a hydrogen storage system may utilize one or more injection wells to supply hydrogen gas to a fractured impermeable or non-permeable subterranean formation. The non-permeable formation may be closed with little or no volumetric capacity to store gas. Hydraulic fracturing operations can create the volumetric capacity within the subterranean formation to store the injected gas. The fracturing operation may include a number of high pressure pumps directing a volume of proppant laden fluid at high pressures and flow rates sufficient to fracture the low porosity formation. The volume of the proppant laden fluid can produce fractures within the formation and provide a flow path filled with propping agent extending into the formation from the wellbore. The gas can then be injected into the fractures that are held open by the proppant. The non-permeable formation, e.g., granite formation, value can retain an injected gas within the network of induced fractures extending from the wellbore. In some embodiments, the non-permeable subterranean formation can be drilled with a curved wellbore path configured to extend, co-mingle, or enhance the fracture network, e.g., plurality of fractures, formed by a fracturing operation. The total area of the fracture network, e.g., fracture stress within the formation, can be increased or enhanced by the curved wellbore path.

In some embodiments, a method to create a subterranean gas storage location can optimize the stress inference between fracture stresses by altering the wellbore path to produce fracture stress interference between fractures along the wellbore. Hydraulic fractures initiate perpendicular to the least principle stress and knowing this allows fracture designs to be developed for this purpose. The volumetric capacity of the formation can be improved and/or increased by increasing the surface area of the formation with fracture stress interference between fractures along the wellbore optimized with a fracture model. The occurrence of fracture stress interference can increase the fracture height and length created along the wellbore. In some embodiments, the wellbore path can be designed with a pattern, e.g., a curved path, in the horizontal plane, the vertical plane, or combination thereof to promote or encourage the occurrence of fracture stress interference. These designed wellbore paths or covered paths, can have more vertical reservoir height covered with a single wellbore to increase the effective reservoir volume exposed through a wellbore servicing operation such as a fracturing operation. The occurrence of fracture stress interference can increase the fracture area and provide a greater volumetric storage space within a single wellbore which may allow for fewer wells drilled in a large scale hydrogen power cycle project comprising multiple injection and/or production wells.

Disclosed herein is a method of lowering the economic cost of a hydrogen power cycle by increasing the available hydrogen gas in storage by designing an injection well with a curved wellbore for an impermeable formation and/or a non-permeable formation. The hydrogen power system can comprise an injection wellbore, a production wellbore, and a hydrogen energy station 114 fluidically coupled to both. The injection area of the curved wellbore can be optimized by designing a fracturing operation to promote fracture interference between stages. The curved wellbore path can include a sinusoidal path or a helical path to further promote fracture interference between stages and increase the injection area of the injection wellbore. The optimization of the injection area can increase the storage capacity and conductive flowrate of the production fluid via the conductive fracture output from the subterranean formation. The increase available hydrogen in response to the containment of hydrogen volume within a non-permeable formation can increase the economic value of the hydrogen energy system.

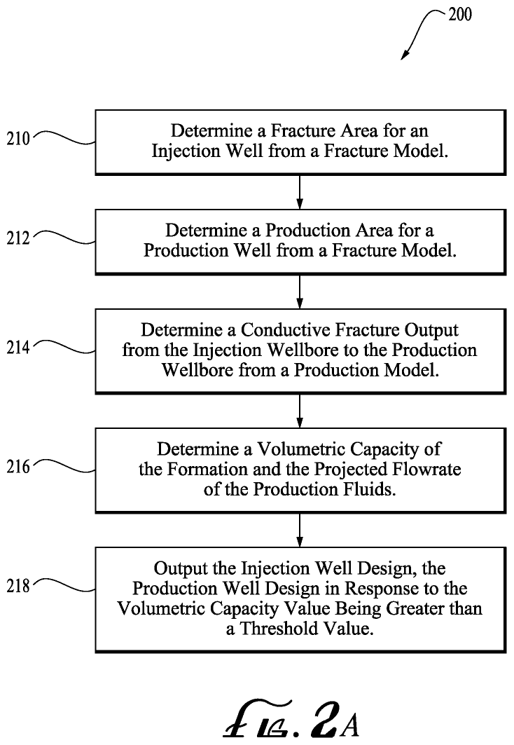

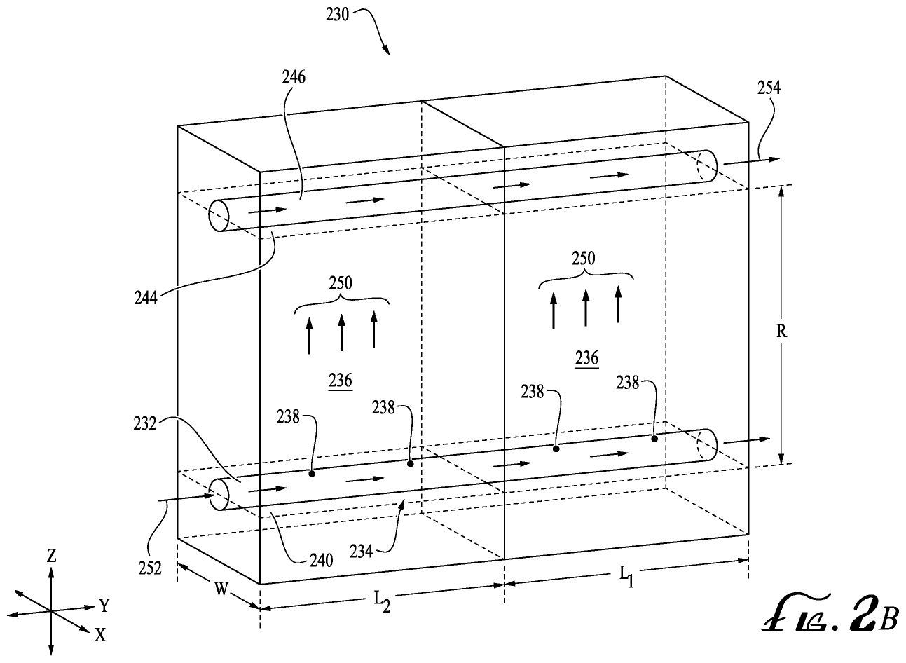

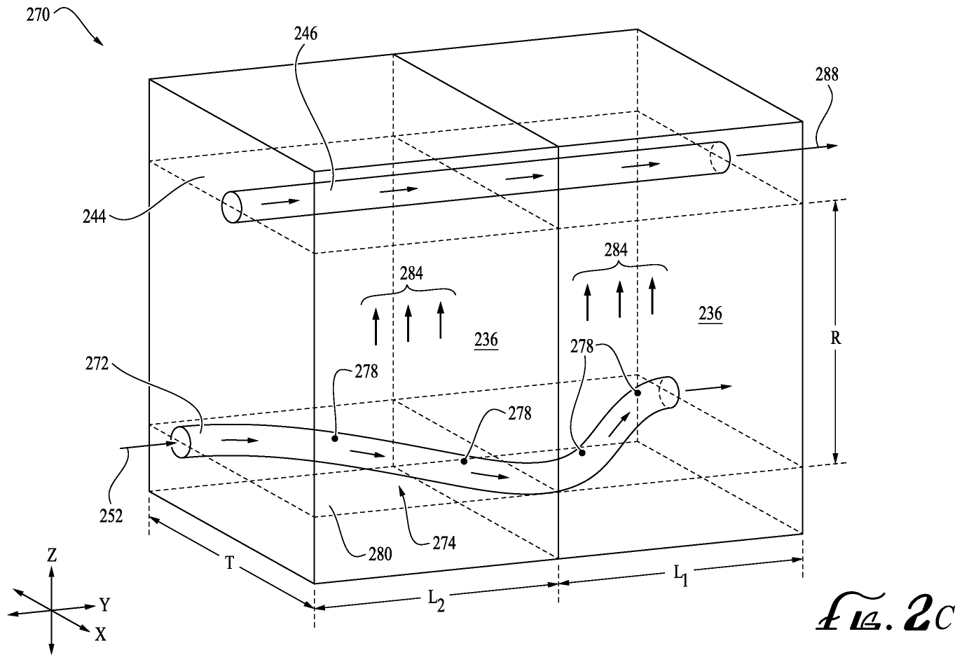

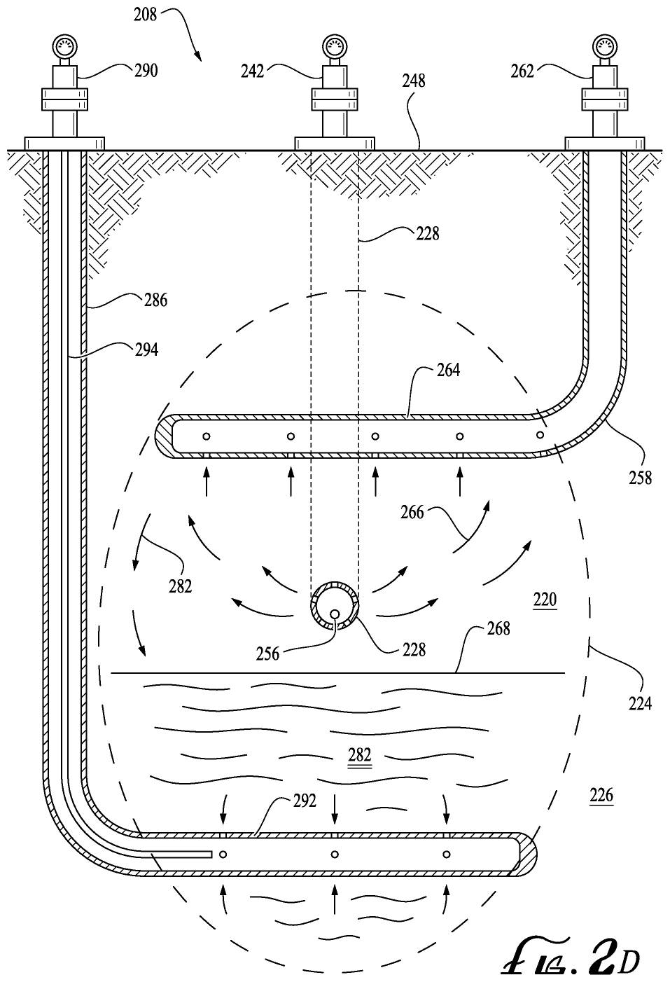

Turning now to FIGS. 2A and 2B, a method for designing a hydrogen energy system is illustrated as a logical block diagram. In some embodiments, a method 200 for designing a hydrogen power cycle system with an injection area of the injection well greater than a production area of the production wellbore can be described. A design process 200 can utilize a fracture model and a production model to determine an economic cost value of producing a hydrogen gas for use in a green energy power plant, e.g., power plant 114 from FIG. 1. In some embodiments, the design process 200 can compare an economic cost value of a conventional hydrogen system comprising an injection well with a generally straight and/or horizontal injection well in a depleted reservoir to an improved hydrogen system comprising an injection well with a curved wellbore path in a non-permeable reservoir.

Turning now to FIG. 2B, a conventional fracturing system 230 can be described. The conventional fracturing operation can comprise an injection wellbore 232 with a generally straight and/or horizontal wellbore path 234 penetrating a subterranean formation 236 suitable for gas storage, e.g., porous reservoir. The injection wellbore 232 can comprise a drilled wellbore (not shown), a casing string (shown), a cement sheath (not shown), or any combination thereof. The drilled wellbore and cement sheath are not illustrated for clarity. The injection wellbore 232 can comprise a plurality of initiation points 238.

At block 210 of FIG. 2A, the design process 200 can determine a fracture area 240 for an injection wellbore 232 with a fracture model. The fracture area 240 comprises a projected area of the volume of fracturing fluids extending into the subterranean formation 236. The volume of fracturing fluids from a fracturing operation induces a set of fracture stresses within the subterranean formation 236. The fracture area 240 can be approximated by a planar surface with a unit length “L” and a unit width “W.” The fracture model can determine the fracture area 240 from the injection wellbore geometry, a set of geomechanical data for the subterranean formation 236, a first fracturing operation, or combinations thereof. The set of geomechanical data comprises formation composition, porosity, depth, temperature, fracture plane orientation, or combinations thereof. The injection wellbore geometry comprises a borehole, a casing string, a cement sheath, or combinations thereof.

Created fracture area is the surface area of the fracture faces that are created during the hydraulic fracturing process, typically measured in square feet. Since each fracture has 2 faces, the effective fracture area created can simplistically be thought of as the created fracture length multiplied by the created fracture height multiplied by 2. This summation would be applied to every fracture that is created within the rock volume. The total created fracture area would be the sum of all of the created fracture area.

In some embodiments, the first fracturing operation comprises a completion operation and a pumping operation for a plurality of fracturing stages. The completion operation comprises a wellbore operation to open a plurality of initiation points 238 in the casing string, e.g., injection wellbore 232. The pumping operation comprises pumping a fracturing fluid according to a pumping schedule into the wellbore geometry of the injection well. The fracturing fluid can comprise a carrier fluid, e.g., water, and a proppant, e.g., ceramic particles. In some embodiments, the proppant can be ceramic particles and/or spheres made from crush and temperature resistant materials, for example, sintered bauxite, kaolin, magnesium silicate, or combinations, e.g., blends, thereof. In some embodiments, a thermally stable coating may be added to the outside of the ceramic particles. The pumping schedule can include a plurality of steps or intervals to place a designation volume of fracturing fluid at a predetermined pumping pressure, flowrate, and concentration of proppant into the subterranean formation 236. In some embodiments, the completion operation can open a plurality of initiation points 238 for a fracturing stage, for example, a first fracturing stage. The pumping operation can fracture the formation 236 by injecting the fracturing fluids into the formation 236 via the initiation points 238. The fracturing operation can be designed to generate a predetermined level of fracture stress within the formation 236. In some embodiments, the fracturing operation opens a plurality of fracture initiation points, initiation points 238, corresponding to a portion of the injection wellbore 232 referred to as a fracture stage. In some embodiments, the unit length “L” can be a fracture stage. For example, FIG. 2B can illustrate a first fracture stage “L1” and a second fracture stage “L2.”

At block 212 of FIG. 2A, the design process 200 can determine a production area 244 for a production wellbore 246 with a fracture model. The production area 244 can be determined by the first fracturing operation of the injection wellbore 232, a second fracturing operation of the production wellbore 246, or combinations thereof. In some embodiments, the drilled wellbore for the production wellbore 246 can be located within the fracture stresses of the first fracturing operation for the injection wellbore 232. For example, the production wellbore 246 can be located within the fracture stresses extending from the initiation points 238 of the injection wellbore 232 when the distance “R” from injection wellbore 232 to the production wellbore 246 is a small value. In some embodiment, the drilled wellbore for the production wellbore 246 can be located outside of the fracture stresses of the first fracturing operation for the injection wellbore 232, for example, when the distance “R” from injection wellbore 232 to the production wellbore 246 is a large value. In some embodiments, a second fracturing operation can open initiation points (not shown) in the production wellbore, place a filtering media within the production wellbore 246, create a second set of fracture stresses with a pumping operation, or combinations thereof. For example, the second fracturing operation can open a set of initiation points with a completion operation, e.g., with perforating guns. In another scenario, the second fracturing operation can open a set of initiation points and place a filtering media into the production wellbore, e.g., sand screens and/or filter media. In still another scenario, the second fracturing operation can further comprise a pumping operation to generate fracture stresses extending from the initiation points within the production wellbore 246.

The production area 244 of the production wellbore 246 can be determined by inputting the second wellbore geometry, e.g., production wellbore 246 and the second fracturing operation into the fracture model. The second wellbore geometry comprises a generally horizontal wellbore path that is i) located within the plurality of fracture stresses of the first fracturing operation, ii) located outside of the plurality of fracture stresses of the first fracturing operation, or combinations thereof. The second fracturing operation can include opening a plurality of initiation points within the production wellbore 246, placing a filter media inside the production wellbore 246, a pumping operation to place a fracturing fluid into the formation 236, or combinations thereof.

At block 214 of FIG. 2A, the design process 200 can determine a conductive fracture flowrate 250 from the first wellbore, e.g., the injection wellbore 232, to the second wellbore, e.g., the production wellbore 246, with a production model. The conductive fracture flowrate 250 can be a function of the injection pressure at the formation face in the injection well, the flowrate of the injection fluid 252, the fracture stress value of the first fracturing operation, the fracture stress value of the second fracturing operation, or combinations thereof and the inlet pressure of the production well. For example, the differential pressure from the injection well, e.g., injection pressure of the injection fluid, and production well, e.g., production pressure of the production fluid, that drives the injection fluid from the injection well across the fracture stress within the subterranean formation to the producing well and the conductivity of the created fracture, e.g., fracture stress, that determines the flow rate of the fluid that can be established for the given pressure differential. The production model can output a temperature, a pressure, and a flowrate of the production fluid 254, e.g., hydrogen gas.

At block 216 of FIG. 2A, the design process 200 can determine a volumetric capacity of the formation, a projected value for the rate of production of the production fluid 254, an economic value of the production fluid 254 as a function of the properties of the injection fluid 252 and the properties of the production fluid 254, or combinations thereof. For example, the volumetric capacity of the formation 236 can be a function of the fracture area 240 of the injection wellbore 232, the fracture area 244 of the production wellbore 246, or combinations thereof. In another scenario, the economic value of the production fluid 254 may be based on the available volume of the production fluid, the flowrate of the production fluid 254, and the cost of generating and injecting the injection fluid 252 into the injection wellbore 232. In some embodiments, the economic value of the production fluid 254 can include the price of the electricity generated by the power generation, e.g., power generation 114.

At block 218, the design process 200 can output the design of the injection wellbore 232 and the design of the production wellbore 246 in response to the volumetric capacity of the formation 236 being greater than a threshold value, the economic value of the production fluid 254 being greater than a threshold value, or combinations thereof. In some embodiments, the design of the injection wellbore 232 comprises the wellbore geometry, the wellbore path, a first fracturing operation, or combinations thereof. In some embodiments, the design of the production wellbore 246 comprises the production wellbore geometry, the production wellbore path, the second fracturing operation, or combinations thereof.

The volumetric capacity of the formation 236 can be increased with a curved wellbore path. Turning now to FIG. 2C, an improved storage system 270 with a curved wellbore can be described. In some embodiments, the improved storage system 270 comprises an injection wellbore 272 with a curved wellbore path 274 penetrating a subterranean formation 236 suitable for gas storage, e.g., non-permeable rock. The curved wellbore path 274 can be sinusoidal in shape with an amplitude and period. The amplitude of the sinusoidal wellbore path 274 can be half the distance “T.” The period of the sinusoidal wellbore path 274 can be the combined length of “L1” and “L2.” The injection wellbore 272 can comprise a drilled wellbore, a casing string, a cement sheath, or any combination thereof. The injection wellbore 272 is illustrated with only a casing string for clarity. The injection wellbore 272 can comprise a plurality of initiation points 278.

Returning to the design process 200 in FIG. 2A, the design process 200 can determine a fracture area 280 for an injection wellbore 272 with a fracture model. The fracture model can determine the fracture area 280 from the injection wellbore geometry, a set of geomechanical data for the subterranean formation 236, a first fracturing operation, or combinations thereof. The first fracturing operation can include a completion operation to open a plurality of initiation points 278 in the casing string, e.g., injection wellbore 272, and a pumping operation. The pumping operation can be designed to promote fracture interference between each initiation point 278 of the plurality of initiation points 278, between fracture stages, e.g., “L1” and “L2”, or both. For example, the curved wellbore path 274 can promote fracture interference between the fracture stresses extending from the initiation points 278 and from fracture stage “L1” and fracture stage “L2.” The term fracture interference refers to the response of a second fracture plume, e.g., second fracture stress, extending from a fracture initiation point 278 in the casing string to move away from an existing or a first fracture plume, e.g., first fracture stress, and into a portion of the formation 236 that has not been fractured or is without a volume of fracture stress. The curved wellbore path 274 with the predetermined fracture interference of the fracture stresses extending from the initiation points 278 can increase the fracture area 280 of the injection wellbore 272.

The volumetric capacity of the formation 236 can be increased by the materials used to prop open the fractures. In some embodiments, the volumetric storage capacity of the formation 236 can be increased by proppant with porous structures, coatings on the outer surface of the proppant, the material of the proppant, or combinations thereof. For example, a proppant material with a porous structure can store hydrogen on the surface through adsorption or within the porous structure via absorption. Materials that can increase the hydrogen storage include metal hydride materials and metal-organic frameworks (MOFs). Metal hydride materials and/or metal hydride systems increase hydrogen storage by absorbing the hydrogen on the metal surface and then creating or incorporating the hydrogen into a metallic lattice. Metal hydrides are formed from a variety of metals including palladium, magnesium and lanthanum, aluminum, or certain alloys thereof. Hydrogen can be stored as a sorbate by attachment via adsorption via MOFs. The MOFs comprise microporous organometallic framework compounds, microporous crystalline aluminosilicates, microscopically small carbon nanotubes, copper, zinc, chromium, or combinations thereof. The use of porous proppant, coatings that create porous structures, e.g., MOFs, or materials that absorb the hydrogen, e.g., metal hydrides, can increase the storage capacity of the formation 236.

At block 212, the design process 200 can determine a production area 244 for a production wellbore 246 with a fracture model. The production area 244 can be determined by the first fracturing operation of the injection wellbore 272, a second fracturing operation of the production wellbore 246, or combinations thereof. The production area 244 can be a function of the occurrence of fracture interference when the production wellbore 246 intersects or is proximate to the fracture stresses extending from the initiation points 278 of the injection wellbore 272. The production area 244 of the production wellbore 246 can be determined by inputting the second wellbore geometry, e.g., production wellbore 246 and the second fracturing operation into the fracture model.

At block 214, the design process 200 can determine a conductive fracture flowrate 284 from the first wellbore, e.g., the injection wellbore 272, to the second wellbore 246, e.g., the production wellbore 246, with a production model. The conductive fracture flowrate 284 can be a function of the pressure and the flowrate of the injection fluid 252, the fracture stress value of the first fracturing operation, the fracture stress value of the second fracturing operation, or combinations thereof. The total volume, e.g., 3D space, for the injection fluid 252, e.g., hydrogen gas, within the formation 236 can be a function of the increase in fracture area 280 in response to the curved wellbore path 274. The production model can output a temperature, a pressure, and a flowrate of the production fluid 288, e.g., hydrogen gas.

At block 216, the design process 200 can determine a volumetric capacity of the formation 236, a projected value for the rate of the production fluid 288 as a function of the properties of the injection fluid 252 and the properties of the production fluid 288, or combinations thereof. For example, the volumetric capacity of the formation 236 can be a function of the fracture area 240 of the injection wellbore 232, the fracture area 244 of the production wellbore 246, or combinations thereof. In another scenario, the economic value of the production fluid 288 may be based on the available volume of the production fluid, the flowrate of the production fluid 288, and the cost of generating and injecting the injection fluid 252 into the injection wellbore 272. In some embodiments, the economic value of the production fluid 288 can include the price of the electricity generated by the power generation, e.g., power generation 114.

At block 218, the design process 200 can output the design of the injection wellbore 272 with the curved wellbore path 274 and the design of the production wellbore 246 in response to the volumetric capacity being greater than a threshold value, the economic value being greater than a threshold value, or combinations thereof. In some embodiments, the design of the injection wellbore 272 comprises the wellbore geometry, the curved wellbore path 274, a first fracturing operation, or combinations thereof. In some embodiments, the design of the production wellbore 246 comprises the production wellbore geometry, the production wellbore path, the second fracturing operation, or combinations thereof.

In some embodiments, the design process 200 can compare the fracture area 240 generated by the fracturing system 230 to the fracture area 280 generated by the improved storage system 270. For example, the design process 200 may determine that the fracture area 280 generated by the curved wellbore path 274 is 300 percent larger than the fracture area 240 generated by the straight wellbore path 234. In some embodiments, the design process 200 can optimize the fracture area 280 generated by the curved wellbore path 234 to be a predetermined design value greater than the fracture area 240 of the straight wellbore path 234. For example, the design process 200 may iterate the shape of the curved wellbore path 274, the number of fracture stages, e.g., “L2”, the number of initiation points 278, the pumping schedule of the first fracturing operation, or combinations thereof to achieve the design value, e.g., 250 percent. The design value may be 150, 160, 170, 180, 190, 200, 210, 220, 230, 240, 250, 260, 270, 280, 300, 330, 360, 380, 400 percent or any percentage greater than 150 percent.

In some embodiments, the design process 200 can iterate the fracture area 280 generated by the improved storage capacity to achieve an economic value of the production fluid 288. For example, the design process 200 may iterate the shape of the curved wellbore path 274, the number of fracture stages, e.g., “L2”, the number of initiation points 278, the pumping schedule of the first fracturing operation, or combinations thereof to achieve a storage capacity value for the storage of the production fluid 288.

A subterranean hydrogen storage system may comprise one or more wellbores. Turning now to FIG. 2C, a hydrogen storage system can be described. In some embodiments, a hydrogen system 208 can be created within a non-permeable formation 226. The non-permeable formation 226 can comprise a fractured volume 220 with a boundary 224 within the non-fractured portion of the non-permeable formation 226. It is understood that the boundary 224 is for illustrative purposes and that the actual extent of the fractured volume 220 will vary depending on material properties of the formation. An injection wellbore 228 can extend from a wellhead 242 located at surface 248 into the non-permeable formation 226. A fracturing operation can create the fractured volume 220 within the non-permeable formation 226 by pumping a fracturing fluid comprising proppant and a carrier fluid at a predetermined pressure and flowrate into the injection wellbore 228. The proppant and carrier fluid can create fracturing stress extending along a fracturing plane. The carrier fluid can be removed from the fractured volume 220 of the formation 226 by allowing the carrier fluid pressurized by the fracturing stress within the fractured volume 220 to produce, also referred to as flow back, to surface 248 via the injection wellbore 228.

In some embodiments, a portion of the fluid content of the fractured volume can be removed with an artificial lift method. In some embodiments, an artificial lift device 256 can be installed into the injection wellbore 228 to lift, e.g., produce, fluid from the injection wellbore 228. The artificial lift device can comprise a snorkel tube, a gas lift mandrel, an electric submersible pump (ESP), a sucker-rod pump, a jet hydraulic pump, plunger lift, progressive cavity pumps, or combinations thereof. As illustrated in FIG. 2C, a snorkel tube 256 can be located within the casing string of the injection wellbore 228. As fluid, e.g., carrier fluid, fills the inner bore of the casing string, the artificial lift device 256 can remove the fluid by transporting the fluid to a volume at surface 248. The snorkel tube 256 can be a tubular, e.g., threaded tubing or coil tubing, that extends from the wellhead 242. In some embodiments, the fluid within the inner bore of the casing string can be lifted by the applied pressure of the injection fluid, e.g., hydrogen gas, pumped into the injection wellbore 228 via the wellhead 242. In some embodiments, the fluid within the inner bore can be lifted by the artificial lift device coupled to the snorkel tube 256 and located between the wellhead 242 and the bottom of the wellbore 228. The portion of carrier fluid remaining within the fractured volume 220 can decrease the available volume for gas storage.

In a single well scenario, the injection wellbore 228 can also be the production wellbore. For example, a first volume of hydrogen gas may be generated via the hydrogen energy 114 of FIG. 1, compressed at surface, and injected into fractured volume 220 via the injection wellbore 228. A second volume of hydrogen gas may be retrieved from the fractured volume 220 to the hydrogen energy 114 via wellbore 228 for use. In some scenarios, the snorkel tube 256 can remove fluid from the injection wellbore 228.

In some embodiments, the hydrogen system 208 can further comprise a production wellbore 258 within the non-permeable formation 226. The production wellbore 258 can extend from a production wellhead 262 located at surface 248 to a target depth within the fractured volume 220. The production wellbore 258 can comprise a vertical portion and a horizontal portion 264 located at a depth less than, e.g., above, the injection wellbore 228. In a first scenario, a second injection fluid, e.g., hydrogen gas, can be injected into the volume 220 via the production wellbore 258. In a second scenario, a second production fluid, e.g., hydrogen gas, can be retrieved to surface 248 via the production wellbore 258. For example, the storage gas 266, e.g., hydrogen gas located within the volume 220, can migrate upwards (towards the surface) within the volume 220 to enter the production wellbore 264. In some scenarios, a volume of trapped fluid 282, e.g., carrier fluid within the volume 220, can migrate downwards, e.g., away from the surface 248, towards the injection wellbore 228. In some scenarios, the volume of trapped fluid 282 with the fractured volume 220 can be located below a boundary layer 268 or fluid level. For example, the boundary layer 268 may be located at or proximate the injection wellbore 228 in response to the snorkel tube 256 producing fluid to the fluid volume at the surface 248. In some embodiments, the injection fluid, e.g., hydrogen gas, from surface 248 can displace a volume of fluid 282 within the fractured volume 220.

In some embodiments, the hydrogen system 208 can further comprise a third wellbore 286 within the non-permeable formation 226. The third wellbore 286 can extend from a third wellhead 290 located at surface 248 to a target depth within the fractured volume 220. The third wellbore 258 can comprise a vertical portion and a generally horizontal portion 292 located at a greater depth, e.g., below, the injection wellbore 228. In a first scenario, the third wellbore 286 can deliver a third injection fluid, e.g., hydrogen gas, to the volume 220. In a second scenario, the third wellbore 286 can be utilized to produce a third production fluid, e.g., hydrogen gas, to surface 248. In some embodiments, the boundary layer 268 of the volume of trapped fluid 282 with the fractured volume 220 can be located at depth less than, e.g., above, the third wellbore 292. For example, the third wellbore 286 may be located within the volume of trapped fluid 282. In some embodiments, the trapped fluid 282 can be removed or transferred to a volume of fluid located at surface 248 via the third wellbore 286. In some embodiments, a second snorkel tube 294 can be located within the inner passage of the third wellbore 286 can coupled to the wellhead 290. In some embodiments, an artificial lift device can be located between the wellhead 290 and the distal end of the snorkel tube. In some scenarios, the volume of trapped fluid 282 within the wellbore 292 can be lifted or transferred to surface 248 through the snorkel tube 294 via the hydrostatic wellbore pressure and/or the artificial lift device. In some embodiments, the boundary layer 268 may be lowered by producing a volume of trapped fluid 282 to surface 248 and, as a result of producing the volume of trapped fluid 282, the boundary layer 268 may be located below the third wellbore 292. In some embodiments, the third injection fluid, e.g., hydrogen gas, delivered from surface 248 can displace a volume of fluid 282 within the fractured volume 220.

Although the first wellbore 228, the second wellbore 258, and the third wellbore 286 are described as horizontal wellbores, it is understood that one or more of the wellbores, e.g., the third wellbore 286, can be vertical or substantially vertical. Although the first wellbore 228, the second wellbore 258, and the third wellbore 286 are described as horizontal wellbores, it is understood that one or more of the wellbores, e.g., the first wellbore 228, can comprise a curved wellbore path as will be described further herein.

Although the first wellbore 228, the second wellbore 258, and the third wellbore 286 are described in a sequence, it is understood that the wellbores can be drilled in any sequence, for example, the second wellbore, e.g., the production wellbore 258, can be drilled before the first wellbore, e.g., the injection wellbore 228. Although the fracturing operation that produces the volume 220 is described as extending from the first wellbore, the injection wellbore 228, it is understood that two or more wellbores may be drilled before the fracturing operation, e.g., the first wellbore 228 and the second wellbore 258. In some embodiments, the fracturing operation may be performed on two wellbores simultaneously, for example, the fracturing operation can be performed by alternating the pumping operation between the first wellbore 228 and the second wellbore 258 or the first wellbore 228 and the third wellbore 286, or all three wellbores.

In some embodiments, a wellbore stimulation operation may be performed on the hydrogen storage system 208. A pumping operation may pump a stimulation treatment into one or more wellbores to enhance the hydrogen storage capacity of the fractured volume 220. The stimulation treatment may include one or more chemicals selected from a group of methane, toluene, carbazole derivative N-ethylcarbazole, or combinations thereof. In some embodiments, the stimulation treatment can be pumped into the first wellbore 228 and/or the second wellbore 258 and removed via the third wellbore 286. The stimulation operation can be performed periodically to increase the hydrogen capacity of the fractured volume 220.

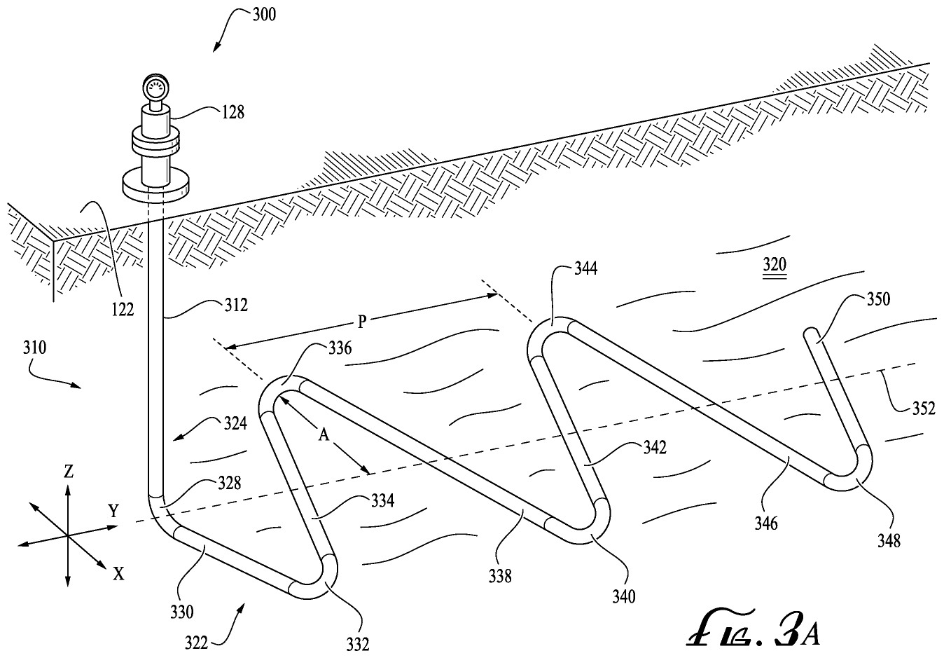

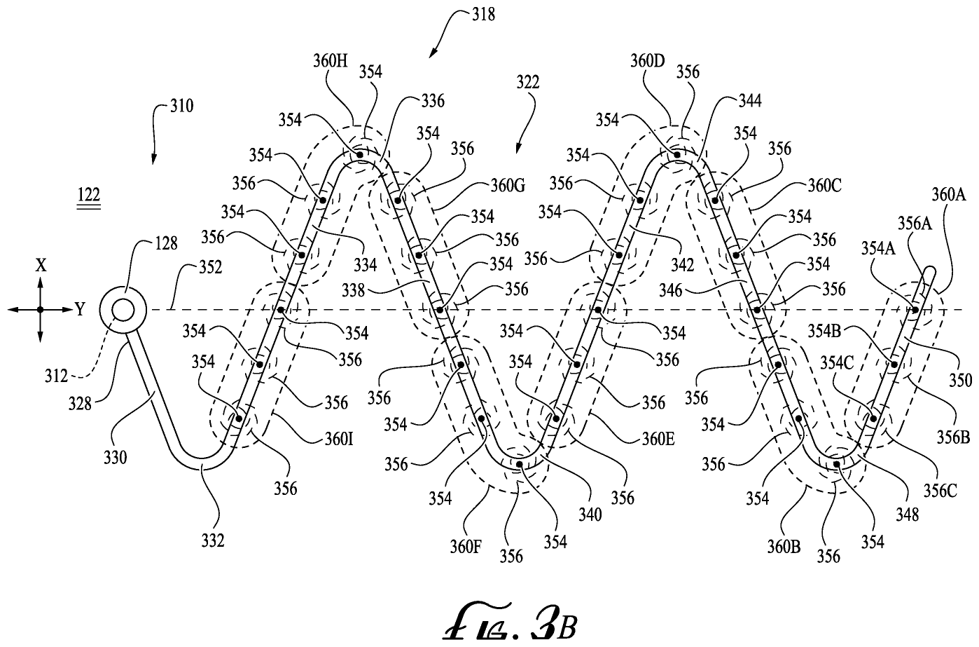

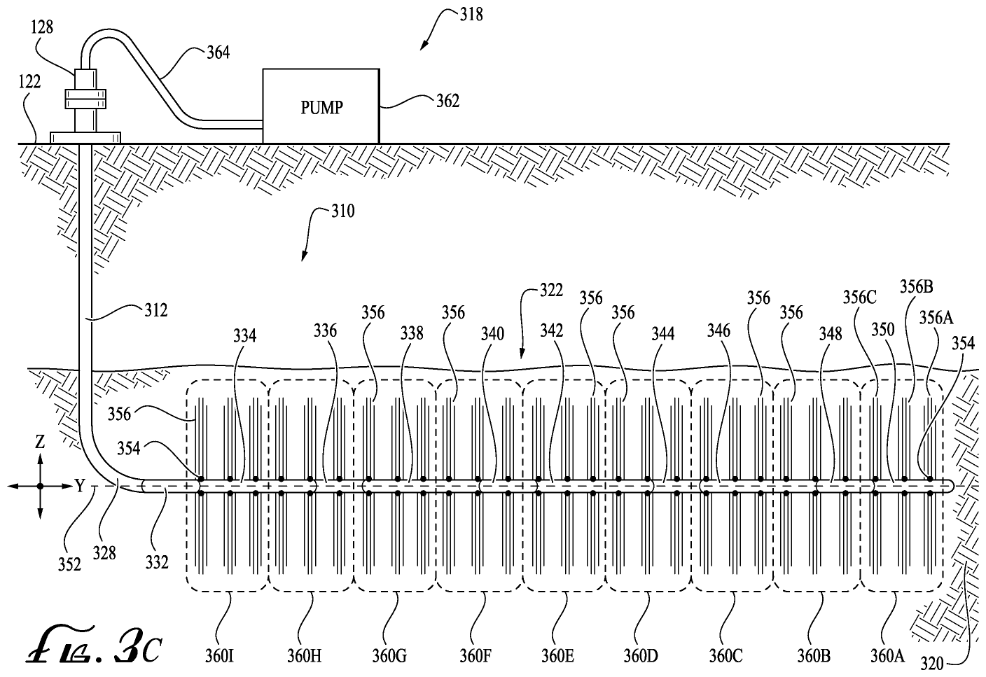

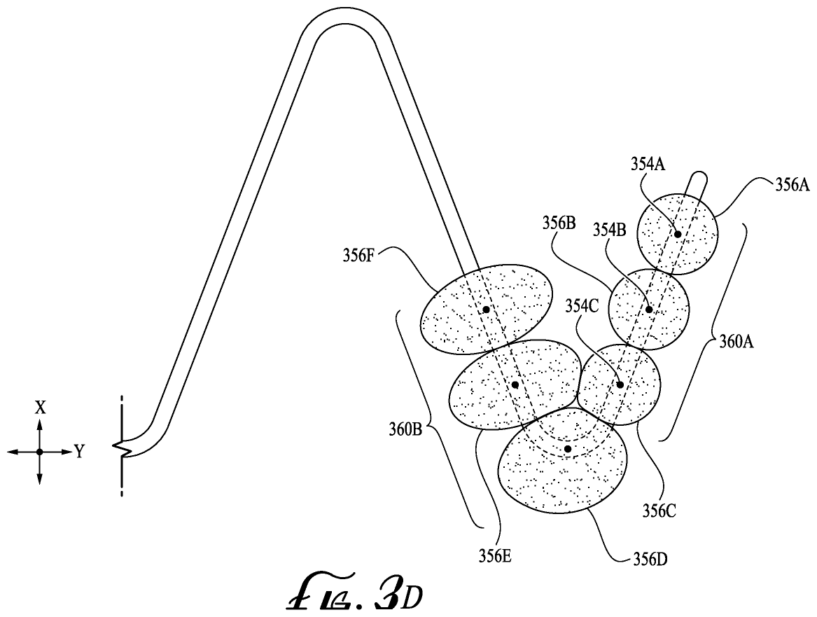

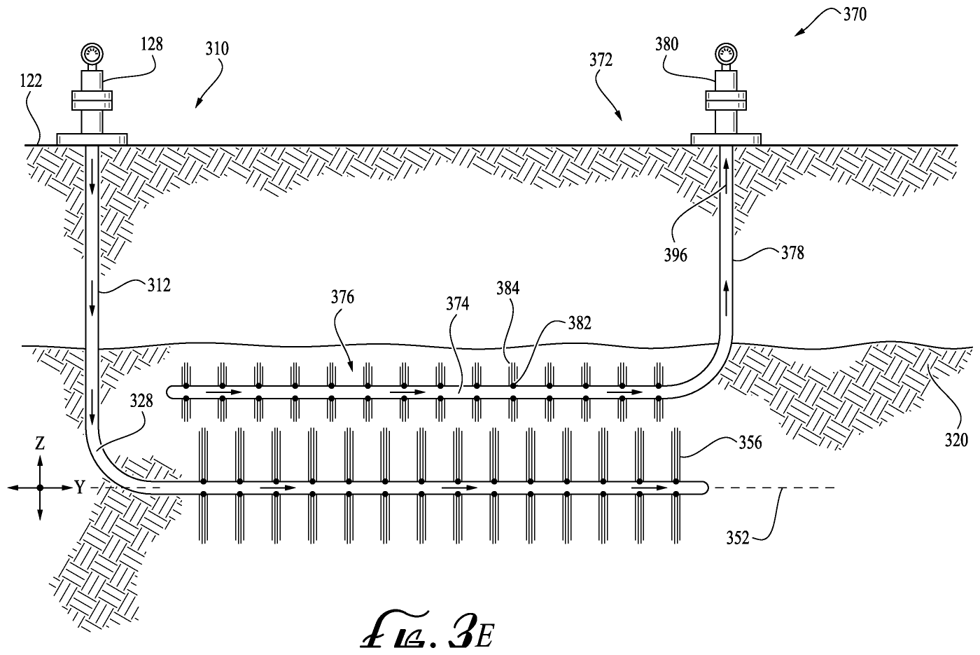

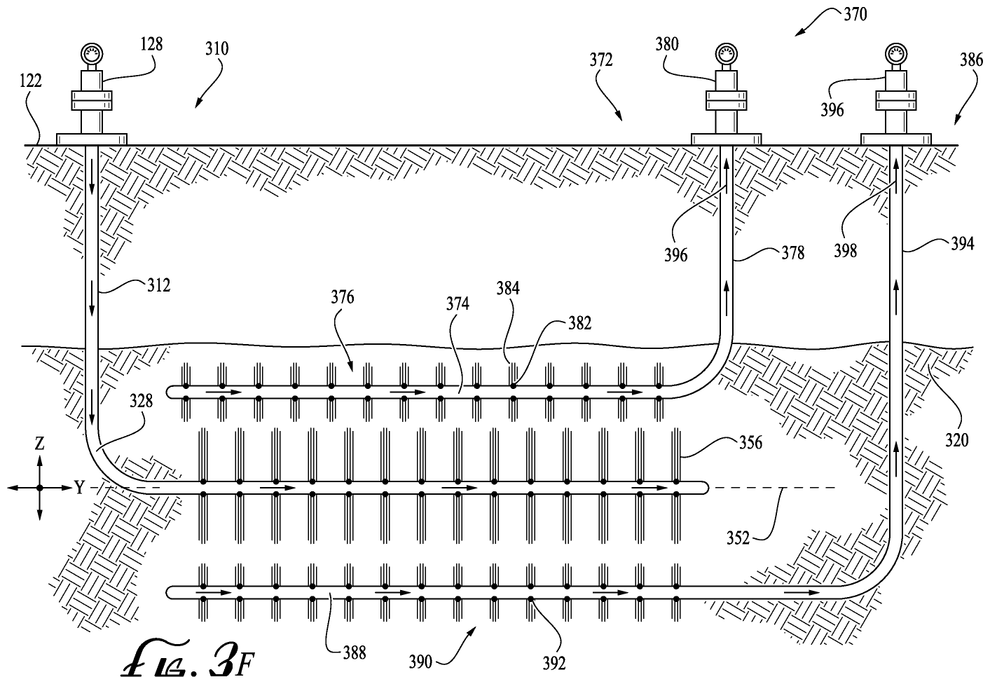

As previously described in FIG. 2C, one or more of the wellbores can comprise a curved wellbore path 274. The shape of the curved wellbore path 274 can be a sinusoidal or a helical shape to increase the occurrence of stress interference between fracture locations and/or fracture stages. Turning now to FIG. 3A, a perspective view of a horizontal sinusoidal injection well environment 300 can be described. In some embodiments, a horizontal sinusoidal injection well 310 can comprise a wellbore drilled with a sinusoidal path into a non-permeable formation 320. A casing string 312 can extend from an injection wellhead 128 at surface 122 into and throughout the wellbore with the sinusoidal path. A cement sheath can be placed between the wellbore and the casing string 312 to anchor and isolate the casing string 312 from the wellbore fluids. Although the wellbore and cement barrier is not illustrated, it is understood that the casing string 312 traverses the sinusoidal wellbore path and the cement may extend from the surface to the toe of the wellbore, e.g., end of casing. As used herein, the term sinusoidal wellbore path comprises a wellbore drilled with any suitable drilling system, a casing string 312, and a cement sheath placed between the wellbore and the casing string 312.

In some embodiments, the injection well 310 comprises a vertical section 324, and a sinusoidal wellbore path 322 extending along a horizontal X-Y plane. The vertical section 324 can be coupled to the wellbore path 322 by a first transition section 328. The sinusoidal wellbore path 322 comprises a first horizontal section 330, a second horizontal section 334, a third horizontal section 338, a fourth horizontal section 342, a fifth horizontal section 346, and a sixth horizontal section 350 generally traversing through the formation 320 along the X-Y plane. The first horizontal section 330 can be coupled to the second horizontal section 334 by a second transition section 332. The second horizontal section 334 can be coupled to the third horizontal section 338 by a third transition section 336. The third horizontal section 338 can be coupled to the fourth horizontal section 342 by a fourth transition section 340. The fourth horizontal section 342 can be coupled to the fifth horizontal section 346 by a fifth transition section 344. The fifth horizontal section 346 can be coupled to the sixth horizontal section 350 by a sixth transition section 348.

The sinusoidal wellbore path 322 can generally follow a sine wave pattern along a y-axis 352 with an amplitude and a period. The amplitude “A” can be defined as half the distance from a first exemplary transition to a second exemplary transition in the x-axis direction of the X-Y plane. For example, the amplitude “A” can be half the distance from the third transition 336 to the fourth transition 340 and can coincide with the y-axis 352 when the third transition 336 and fourth transition 340 are equidistant from the y-axis 352. Although the amplitudes of the sinusoidal wellbore path 322 are illustrated as equivalent, it is understood that the amplitudes from one transition to another transition may vary during the drilling operation for the wellbore.

The period “P” can be defined as the distance in the y-direction of the X-Y plane for the wellbore path to start at a first exemplary location, e.g., a first exemplary transition, to cross the y-axis 352, to travel through an exemplary transition, to cross the y-axis 352, and stop at a second exemplary location, e.g., a second exemplary transition. For example, the period “P” can be a lateral distance parallel to the y-axis 352 from the third transition 336 to the fifth transition 344 and can coincide with the y-axis 352. Although the periods of the sinusoidal wellbore path 322 are illustrated as equivalent, it is understood that the periods from one transition to another transition (on the same side of the y-axis 352) may vary during the drilling operation for the wellbore.

Although the exemplary sinusoidal injection well 310 in FIG. 3A is illustrated with five horizontal sections, e.g., section 334, and 5 transition sections, e.g., transition section 340, it is understood that the sinusoidal injection well 310 can comprise any number of horizontal sections and complementary transition sections, for example, the sinusoidal injection well 310 may comprise 2, 3, 4, 5, 6, 7, 8, 9, 10, or more horizontal sections and complementary transition sections.

The exemplary sinusoidal injection well 310 in FIG. 3A is illustrated with a casing string 312 but without the cement sheath and the wellbore for clarity. Although the sinusoidal wellbore path 322 is illustrated as traversing horizontally along the X-Y plane, it is understood that the sinusoidal wellbore path 322 may also deviate or undulate upwards and downwards (e.g., towards the surface 122 and away from the surface 122) as the sinusoidal wellbore path 322 is drilled through the formation 320. Likewise, the casing string 312 extending through the wellbore (not shown) drilled along the wellbore path 322 may be centralized or not centralized within the drilled wellbore. Said another way, the casing string 312 may or may not be concentric within the drilled wellbore.

The horizontal sinusoidal injection well 310 may be hydraulically fractured to improve a storage capacity within the non-permeable formation 320. The fracturing operation may be performed in stages comprising pumping a fracturing fluid into a portion of the wellbore open to the formation 320. Turning now to FIGS. 3B and 3C, a top view and side view of a fracturing operation environment 318 of a horizontal sinusoidal injection well 310 can be described. In some embodiments, the injection well 310 can be fractured in stages 360 beginning with a first stage 360A. A downhole tool can be lowered from the surface 122 to the sixth horizontal section 350 to open the casing string 312 to the formation 320. The downhole tool can be lowered through wellhead 128 and interior of the casing string 312 to the target horizontal section, e.g., section 350. The downhole tool can be actuated to open an initiation point 354 and fluidically couple the interior of the casing string 312 to the formation 320. In some embodiments, the downhole tool can be a perforating gun assembly with shape charges that shoots or perforates the casing string 312 and the cement sheath to open or create an initiation point 354 and fluidically couple the interior of the casing string 312 to the formation 320. In some embodiments, the downhole tool can be a shifting tool configured to open a casing valve, e.g., a valve coupled to the casing, to open an initiation point 354 coupled to the casing string 312 to the wellbore, the cement sheath, the downhole environment, or combinations thereof.

Turning now to FIG. 3C, the fracturing operation environment 318 can comprise a fracturing fleet, e.g., a plurality of pumps 362, coupled to the wellhead 128 via a high pressure line 364 configured to pump a fracturing fluid according to a pumping schedule, e.g., a sequence of steps comprising fluid volumes and flowrates. The first fracturing operation can produce a fracture plume 356, also referred to as a fracture ellipse, through each initiation point 354 in the casing string 312. The stress level of each fracture stress created from each fracture plume 356 can be a function of the volume of proppant, e.g., sand, displaced into the formation 320. The illustration of the fracture plume 356 represents the fracture growth of the fracture fluid, e.g., proppant and water, cracking or splitting the non-permeable formation 320 and propagating into a vertical fracture plane, e.g., yz-plane. The vertical fracture plane can be generally perpendicular to the horizontal wellbore and/or the axis of the wellbore path 322, e.g., axis 352.

Turning now to FIG. 3D, a top view of the fracturing operation on a portion of the wellbore path 222 of the injection well 310 can be described. In some embodiments, the fracture operation can generate smaller fracture plumes 356 in the first stage 360A. The first stage 360A can comprise multiple fracture plumes 356A-C extending from a plurality of initiation points 354A-C. The first fracture stage 360A may result in smaller fracture plumes 356, and thus smaller volumes of fracture stress, as the fracturing fluid is entering into an un-stressed rock formation. The fracture plumes 356A-C of the first stage 360A can generate an increased stress level, e.g., fracture stress, within the formation 320. The second fracture stage 360B can generate larger fracture plumes 356 extending from each of the initiation points 354. The fracture plumes 356A-C of the first fracture stage 360A can interfere with the fracture plumes 356D-F of the second fracture stage 360B. The fracture interference of a previous fracture stage, e.g., stage 360A, can result in the fracture plumes, e.g., plumes 356D-F, of the current stage growing larger and moving away from the plumes or fracture stress, e.g., plumes 356A-C, of the previous stage. The fracturing operation can be designed to increase the fracture area, e.g., fracture area 280, of the injection well 310 by promoting fracture interference between fracture plumes 356.

Returning to FIGS. 3B and 3C, the fracturing operation can continue from the second fracturing stage 360B to the third fracturing stage 360C and continue until all fracturing stages 360A-I are completed. The fracturing operation can be designed to increase the fracture area, e.g., fracture area 280, of the injection well 310 with fracture interference between fracture stages 360. The number of initiation points 354 and the pump schedule may vary for each fracture stage, e.g., stage 260F, as determined by the design process 200. For example, a fracture stage close to a transition, e.g., transition 340, may have a different number of initiation points 354 and/or a different pump schedule than a fracture stage away from a transition, e.g., stage 260I. Although only three initiation points 354A-C and fracture plumes 356A-C for each stage 360A-I are illustrated, it is understood that each fracture stage 360 can comprise 1, 2, 3, 4, 5, 6, 7, 8, 9, 10, or any number of initiation points 354 and fracture plumes 356.

Turning now to FIG. 3E, a partial sectional view of a gas storage environment 370 can be described. In some embodiments, a hydrogen storage system can comprise a least one injection well 310 and a production well 372, e.g., a second well. The production well 372 can be designed by the design process 200 previously described. The production well 372 can comprise a production wellbore 374, a vertical portion 378, and a first production wellhead 380. The production wellbore 374 can include a generally horizontal wellbore path 376 extending into the formation 320. In some embodiments, the production wellbore 374 can comprise a plurality of initiation ports 382. In some embodiments, the production wellbore 374 can further comprise a plurality of fracture plumes 384 extending into the formation 320. The production wellbore 374 of the first production well 372 can be within or proximate to the fracture plumes 356 of the injection well 310.

In some embodiments, the economic value hydrogen storage system comprising the storage volume, e.g., the fractured volume 220, and the production fluid 396 of the first production well can be determined by the design process 200. In an example, the design process 200 may determine the placement of the first production wellbore 374 proximate to the fracture plumes 356 results in a production fluid 396 with an economic value below a threshold value. In another scenario, the design process 200 may determine the placement of the second production wellbore 388 away from or distal to the fracture plumes 356 results in a production fluid 398 with an economic value above a threshold value. In still another scenario, the design process 200 may determine that the economic value of the first production fluid 396 and second production fluid 398 are below a threshold value and recommend that the wellbore path 322 of the injection wellbore be modified to increase the contact time for the injection fluid within the formation 320.

Turning now to FIG. 3F, a partial sectional view of a gas storage environment 370 can be described. In some embodiments, the a gas storage environment 370 can further comprise a a third wellbore 386, e.g., a second production well 386. The second production well 386 can be designed by the design process 200 previously described. The second production well 386 can comprise a second production wellbore 388, a vertical portion 394, and a second production wellhead 396. The second production wellbore 388 can include a generally horizontal wellbore path 390 extending into the formation 320. In some embodiments, the second production wellbore 388 can comprise a plurality of initiation ports 392. In some embodiments, the second production wellbore 388 can further comprise a plurality of fracture plumes extending into the formation 320. The second production wellbore 388 of the second production well 386 can be located within or hydraulically coupled to the fracture plumes 356 of the injection well 310.

In some embodiments, the third wellbore 386 can produce a production fluid, e.g., hydrogen gas, and/or a wellbore fluid, e.g., trapped volume of fluid. As described in FIG. 2D, a third wellbore 386 can produce a volume of trapped fluid within the fractured volume of the formation 320 to a fluid volume, e.g., storage tank, on surface 122. In some embodiments, the production of the wellbore fluid can increase the gas storage capacity of the fractured volume and thus increase the economic value of the gas storage system.

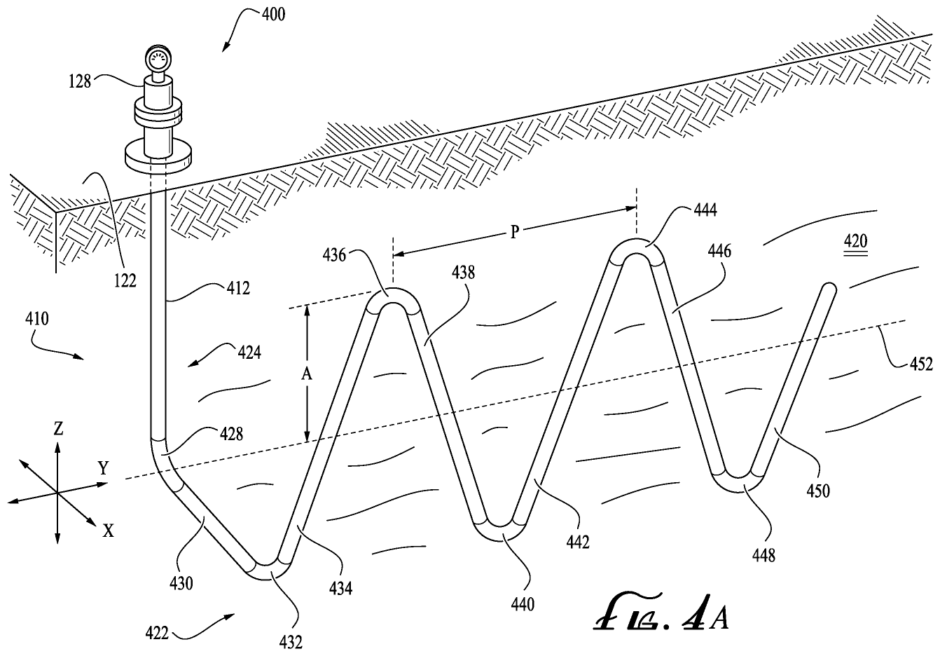

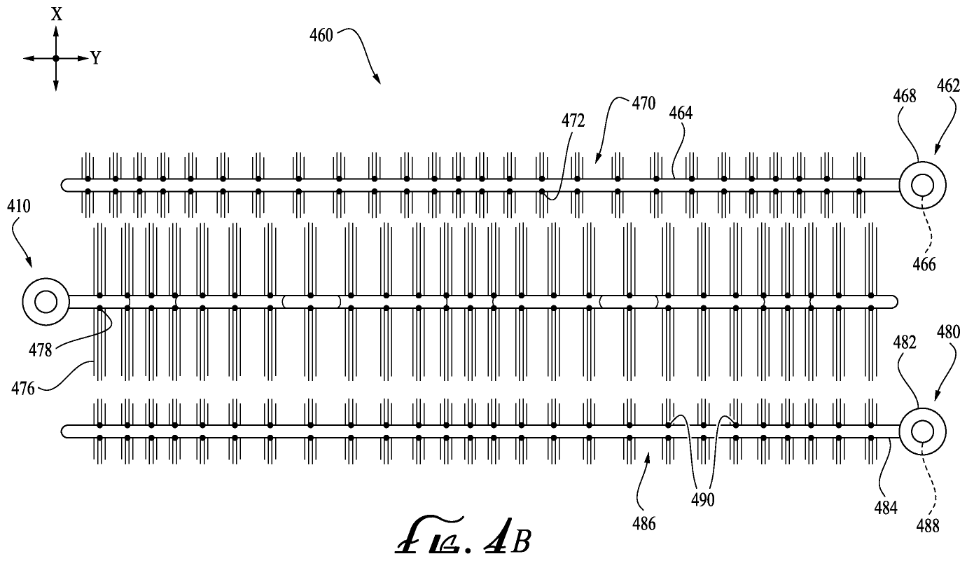

Although the previous example comprised the curved wellbore path in the horizontal plane, the curved wellbore path can be a sinusoidal shape in the vertical plane. Turning now to FIG. 4A, a perspective view of a vertical sinusoidal injection well environment 400 can be described. In some embodiments, a vertical sinusoidal injection well 410 can comprise a wellbore drilled with a vertical sinusoidal path into a target non-permeable formation 420. The vertical sinusoidal wellbore can comprise a casing string 412, a cement sheath, and a drilled wellbore. The vertical sinusoidal wellbore can extend from an injection wellhead 128 at surface 122 into a formation 420.

In some embodiments, the injection well 410 comprises a vertical section 424, and a sinusoidal wellbore path 422 extending along a vertical Y-Z plane. The vertical section 424 can be coupled to the wellbore path 422 by a first transition section 428. The sinusoidal wellbore path 422 comprises a first vertical section 430, a second vertical section 434, a third vertical section 438, a fourth vertical section 442, a fifth vertical section 446, and a sixth vertical section 450 generally traversing through the formation 420 along the Y-Z plane. The first vertical section 430 can be coupled to the second vertical section 434 by a second transition section 432. The second vertical section 434 can be coupled to the third vertical section 438 by a third transition section 436. The third vertical section 438 can be coupled to the fourth vertical section 442 by a fourth transition section 440. The fourth vertical section 442 can be coupled to the fifth vertical section 446 by a fifth transition section 444. The fifth vertical section 446 can be coupled to the sixth vertical section 450 by a sixth transition section 448.

The sinusoidal wellbore path 422 can generally follow a sine wave pattern along a y-axis 452 with an amplitude and a period. The amplitude “A” can be defined as half the distance from a first exemplary transition to a second exemplary transition in the z-axis direction of the Y-Z plane. For example, the amplitude “A” can be half the distance from the third transition 436 to the fourth transition 440 and can coincide with the y-axis 452 when the third transition 436 and fourth transition 440 are equidistant from the y-axis 452. Although the amplitudes of the sinusoidal wellbore path 422 are illustrated as equivalent, it is understood that the amplitudes from one transition to another transition may vary during the drilling operation for the wellbore.

The period “P” can be defined as the distance in the y-direction of the Y-Z plane for the wellbore path to start at a first exemplary location, e.g., a first exemplary transition, to cross the y-axis 452, to travel through an exemplary transition, to cross the y-axis 452, and stop at a second exemplary location, e.g., a second exemplary transition. For example, the period “P” can be a lateral distance parallel to the y-axis 452 from the third transition 436 to the fifth transition 444 and can coincide with the y-axis 452. Although the periods of the sinusoidal wellbore path 422 are illustrated as equivalent, it is understood that the periods from one transition to another transition (on the same side of the y-axis 452) may vary during the drilling operation for the wellbore.

Although the exemplary sinusoidal injection well 410 in FIG. 4A is illustrated with five vertical sections, e.g., section 434, and 5 transition sections, e.g., transition section 440, it is understood that the sinusoidal injection well 410 can comprise any number of vertical sections and complementary transition sections, for example, the sinusoidal injection well 410 may comprise 2, 3, 4, 5, 6, 7, 8, 9, 10, or more vertical sections and complementary transition sections.

Turning now to FIG. 4B, a top view of a gas storage environment 460 can be described. In some embodiments, a gas storage system can comprise a least one injection well 410 and at least one production well 462. The production well 462 can be designed by the design process 200 previously described. The production well 462 can comprise a production wellbore 464, a vertical portion 466, and a first production wellhead 468. The production wellbore 464 can include a generally horizontal wellbore path 470 located above, e.g., at a depth less than the injection wellbore, extending into the formation 420. In some embodiments, the production wellbore 464 can comprise a plurality of initiation ports 472 and can be within or proximate to the fracture plumes 476 of the injection well 410.

In some embodiments, a fracturing operation can create a plurality of fractures within formation 420 after at least one production well, production well 462, is completed. For example, the injection well 410 can be drilled and completed with a string of casing and supported with a cement sheath. The completion of the injection well 410 can be followed by the drilling and completion of the production well 462. In some embodiments, a fracturing operation can be performed on the injection well 410 while monitoring the fracture propagation with sensors placed inside the production well 462. In some embodiments, the fracture operation on both the injection well 410 and the production well 462 can be performed simultaneously. For example, a first fracture stage can be pumped from the injection well 410 followed by a second fracture stage pumped from the production well 462. In some embodiments, the fracture operation can comprise fracturing the injection well 410 while taking returns from the production well 462.

As previously described, the fracturing operation can comprise of a fracturing fleet, e.g., a plurality of pumps 362, coupled to the injection wellhead 128 to deliver a fracturing fluid according to a pumping schedule, e.g., a sequence of steps comprising fluid volumes and flowrates. The first fracturing operation can include a completion operation to open a plurality of initiation points 478 along the sinusoidal wellbore. The first fracturing operation can produce a plurality of fracture plumes 476 through each initiation point 478 in the casing string 412. The stress level of each fracture stress created from each fracture plume 476 can be a function of the volume of proppant, e.g., sand, displaced into the formation 420. The illustration of the fracture plume 476 represents the fracture growth of the fracture fluid, e.g., proppant and water, cracking or splitting the non-permeable formation 420 and propagating into a horizontal fracture plane, e.g., xy-plane. The horizontal fracture plane can be generally parallel to the horizontal wellbore and/or the axis of the wellbore path 422, e.g., axis 452.

In some embodiments, the gas storage system can comprise a second production well 480, e.g., the third wellbore. The second production well 480 can be designed by the design process 200 previously described. The second production well 480 can comprise a second production wellbore 484, a vertical portion 488, and a second production wellhead 482. The second production wellbore 484 can include a generally horizontal wellbore path 486 below, e.g., at a depth greater than the injection wellbore, extending into the formation 420. In some embodiments, the second production wellbore 484 can comprise a plurality of initiation ports 490. In some embodiments, the second production wellbore 484 can further comprise a plurality of fracture plumes extending into the formation 420. The second production wellbore 484 of the second production well 480 can be located away from or out of the influence of the fracture plumes 476 of the injection well 410.

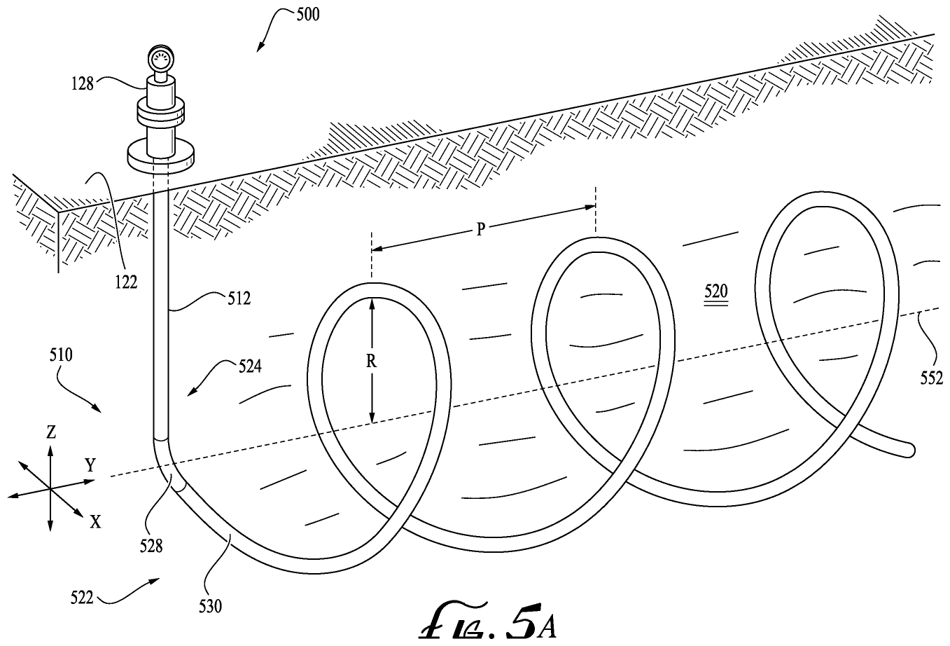

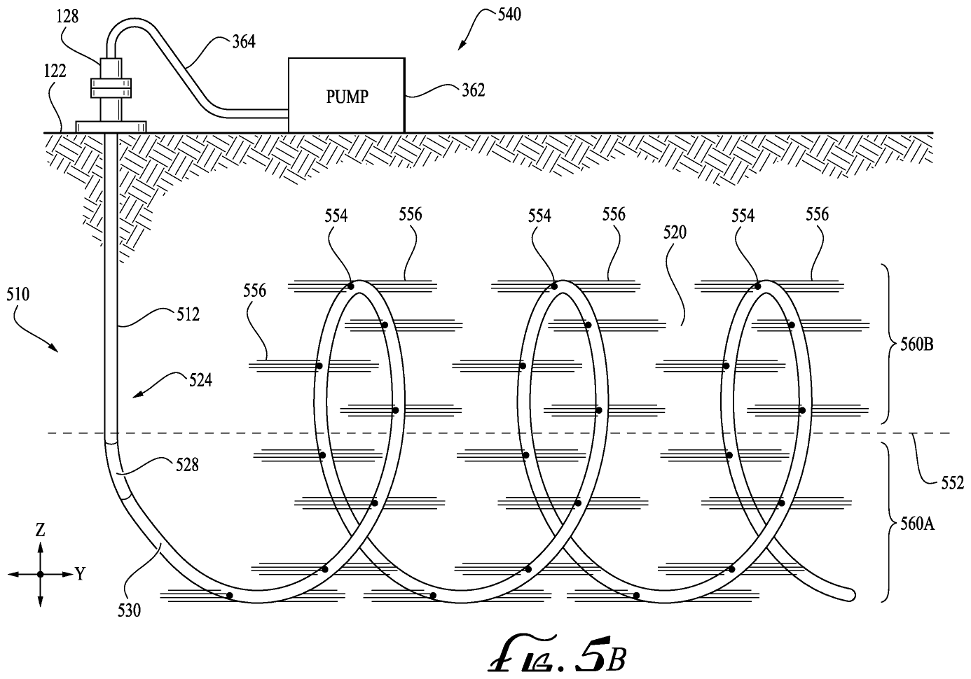

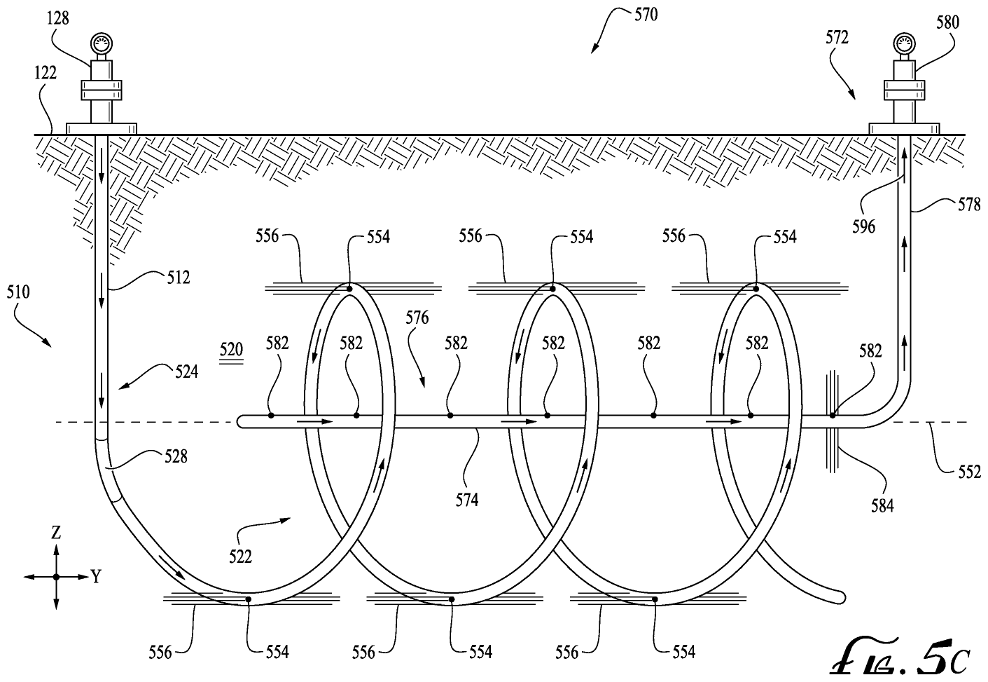

Turning now to FIG. 5A, a perspective view of a helical injection well environment 500 can be described. In some embodiments, a helical injection well 510 can comprise a wellbore drilled with a horizontal helical path into a non-permeable formation 520. The horizontal helical wellbore can comprise a casing string 512, a cement sheath, and a drilled wellbore. The helical wellbore can be coupled to an injection wellhead 128 at surface 122 by a vertical section 524.

In some embodiments, the injection well 510 comprises a helical wellbore path 522 extending along a wellbore axis, e.g., y-axis 552. The vertical section 424 can be coupled to the helical wellbore path 522 by a first transition section 528. The helical wellbore path 522 comprises a curved section 530 extending from a wellbore axis 552 by a radial distance “R.” The curved section 530 can travel a longitude distance “P” along the wellbore axis 552 for each 360 degree revolution. Although the curved section 530 of the helical wellbore path 522 is illustrated with 3.25 revolutions, it is understood that the curved section 530 following the helical wellbore path 522 may include 1, 2, 3, 4, 5, 6, 7, 8, 9, 10 or any whole number of revolutions and/or any fraction of a revolution, for example, 0.10, 0.25, 0.50, 0.75, 0.90, or any fraction between 0 to 1.

Turning now to FIG. 5B, a perspective view of a fracturing operation environment 540 can be described. In some embodiments, a fracturing operation can comprise a fracturing fleet, e.g., a plurality of pumps 362, coupled to the wellhead 128 via a high pressure line 364 pumping a fracturing fluid according to a pumping schedule. A first fracturing operation can produce a fracture plume 556, also referred to as a fracture ellipse, through each initiation point 554 in the casing string 512. The stress level of each fracture stress created from each fracture plume 556 can be a function of the volume sand displaced into the formation 520. The illustration of the fracture plume 556 extending generally parallel and/or longitudinally to the wellbore axis 552 represents the fracture growth and propagation into a vertical fracture plane, e.g., yz-plane.

As previously described, the fracturing operation can comprise a plurality of stages and begin with a first stage 560A. The first stage 560A can comprise a plurality of fracture plumes 556A-C extending from a plurality of initiation points 554A-C. The second stage 560B can comprise one or more fracture plumes redirected or displaced by fracture interference from the first stage 560A. The fracturing operation can be designed to increase the fracture area, e.g., fracture area 280, of the injection well 510 by promoting fracture interference between fracture plumes 556.

Turning now to FIG. 5C, a partial sectional view of a gas storage environment 570 can be described. In some embodiments, a gas storage system can comprise a least one injection well 510 and at least one production well 572. The production well 572 can be designed by the design process 200 previously described. The production well 572 can comprise a production wellbore 574, a vertical portion 578, and a first production wellhead 580. The production wellbore 574 can include a generally horizontal wellbore path 576 extending into the formation 520. In some embodiments, the production wellbore 574 can comprise a plurality of initiation ports 582. In some embodiments, the production wellbore 574 can further comprise a plurality of fracture plumes 584 extending into the formation 520. As illustrated in FIG. 5C, the plurality of fracture plumes 584, e.g., vertical fractures, can be generated in the direction of the maximum horizontal stress (the Y-direction) and can be longitudinal to the producing wellbore. The plurality of fracture plumes 584, e.g., vertical fractures, may (or may not) actually be longitudinal and may be at an oblique angle to the producing wellbore as they follow the direction of maximum stress. The production wellbore 574 of the first production well 572 can be located within the helical wellbore path 522 of the injection well 510.

In some embodiments, the gas storage system can comprise a second production well, e.g., the third wellbore. The second production well can be designed by the design process 200 previously described. The second production well can comprise a second production wellbore, a vertical portion, and a second production wellhead. The second production wellbore can include a generally horizontal wellbore path below, e.g., at a depth greater than the injection wellbore, extending into the formation 520. For example, the second production wellbore can be located below or at a depth greater than the deepest placement of the helical wellbore path 522. In some embodiments, the second production wellbore can comprise a plurality of initiation ports. In some embodiments, the second production wellbore can further comprise a plurality of fracture plumes extending into the formation 520. The second production wellbore of the second production well can be located within or fluidically coupled to the fracture plumes 556 of the injection well 510.

In some embodiments, the economic value of the gas storage system can be a function of the gas storage capacity and the flowrate of the production fluid 596 of the production well 572 and can be determined by the design process 200. In an example, the design process 200 may determine the placement of the production wellbore 574 within the helical wellbore path 522 results in a production fluid 596 with an economic value below a threshold value. In another example, the design process 200 may determine the placement of the production wellbore 574 within the helical wellbore path 522 and with a second fracturing operation results in a production fluid 596 with an economic value above a threshold value.

The curved wellbore path of the horizontal wellbore path 322 (as shown in FIG. 3A), the vertical wellbore path 422 (as shown in FIG. 4A), the helical wellbore path 522 (as shown in FIG. 5A), or combinations thereof could be used to increase the fracture stress area to provide additional volumetric capacity, for example, increased volume for storage of hydrogen gas as described herein. A fracture operation can be performed on a first wellbore, e.g., injection wellbore, with the curved wellbore path to provide a fractured volume 220 within a non-permeable formation 226. The curved wellbore can be configured to increase the fracture area by promoting fracture interference. A proppant within a fracturing fluid can prop open the fractures created by the fracturing operation. One or more types of proppant and/or coatings applied to the proppant can increase the volumetric capacity of the fractured volume 220 by enhancing hydrogen absorption. A volume of hydrogen gas can be produced at surface, compressed, and pumped into the fractured volume 220 via the injection wellbore 228. One or more production wellbores, e.g., wellbore 258, can be placed within or fluidically coupled to the fractured volume 220 to increase the available volume of hydrogen gas in storage. A third wellbore, e.g., wellbore 286, can be placed within or fluidically coupled to the fractured volume 220 at a depth greater than the injection wellbore 228. One or more snorkel tubes, e.g., snorkel tube 256 and/or snorkel tube 294, can be configured to increase the available volume of the fractured volume 220 for gas storage by producing, e.g., removing, trapped fluid 282 from the fractured volume 220.

The present systems and methods for storing hydrogen underground have numerous advantages our other systems and methods for underground gas storage. For example, gases can be stored underground in salt caverns, natural aquifers, depleted gas fields, or similar large scale subterranean structures. Salt domes are large salt deposits typically located underground and can be greater than a mile wide. However, a salt dome must be converted into a salt cavern, via physical mining or by solution mining, for gas storage, which may be time consuming, expensive, and produce by-products (e.g., saturated brine) that is difficult to dispose of. Natural aquifers are located deep underground and may be suitable for gas storage if the water-bearing sedimentary rock formation is overlaid with an impermeable caprock. These natural aquifers are typically in permeable formations with a pre-existing volume of water that must be displaced by the injected gas. Depleted oil and gas fields are permeable formations with little or no recoverable hydrocarbons. The depleted oil and gas fields generally need a structure similar to natural aquifers including the porous structure, an anticline shape volume, and an impermeable caprock. Such structures with suitable naturally-occurring features such as caprock may be relatively rare or located far away from a source of produced hydrogen needing convenient, local storage. In some cases, a significant volume of injected gas may not be recoverable from a natural aquifer or depleted oil field due to leak off and/or chemical reaction within the formation, e.g., with water and/or methane. The suitability of the salt caverns, natural aquifers, and deleted oil and gas fields for hydrogen storage may depend on the location and the geologic structure. The new subterranean storage structure and processes disclosed herein address these shortcoming of other underground gas storage by allowing for creation of underground storage where natural storage conditions may not be present (e.g., at a location proximate a hydrogen production site) and/or allowing for customization of the storage volume (e.g., creation of fracture volume in low permeability formation strata) and related characteristics thereof as described herein.

### Additional Disclosure

The following are non-limiting, specific embodiments in accordance with the present disclosure:

A first embodiment, which is a system for storing gas within a subterranean formation, comprising: a first wellbore comprising a curved wellbore path extending into the subterranean formation from a first wellhead at a surface location; a fractured volume of the subterranean formation comprising a volume of proppant within a fracture network, wherein the fracture network is in response to a fracturing operation, wherein a volume of proppant is enhanced by the curved wellbore path, and wherein the subterranean formation is a non-permeable formation; a gas source fluidically coupled to the first wellhead and configured to pump a compressed gas into the fractured volume via the first wellbore; and wherein the fractured volume within the non-permeable formation is configured to store the compressed gas.

A second embodiment, which is the method of the first embodiment, wherein the curved wellbore path of the first wellbore comprises a sinusoidal wellbore path with a vertical portion coupled to the first wellhead.

A third embodiment, which is the method of any of the first and second embodiment, wherein the curved wellbore of the first wellbore comprises a helical wellbore path with a vertical portion coupled to the first wellhead.

A fourth embodiment, which is the method of any of the first through the third embodiments, wherein the curved wellbore path with the helical wellbore path is drilled along or generally coincident to a fracture plane of the subterranean formation.

A fifth embodiment, which is the method of any of the first through the fourth embodiments, further comprising: a second wellbore comprising a generally horizontal wellbore penetrating the subterranean formation from a second wellhead at the surface location, and wherein the second wellbore is fluidically coupled to the first wellbore via the fractured volume.

A sixth embodiment, which is the method of any of the first through the fifth embodiments, wherein the generally horizontal wellbore of the second wellbore is located i) above or ii) below the curved wellbore with a sinusoidal wellbore path in a horizontal plane.

A seventh embodiment, which is the method of any of the first through the sixth embodiments, wherein the curved wellbore with a sinusoidal wellbore path in a horizontal plane is drilled perpendicular to a fracture plane of the subterranean formation.

An eighth embodiment, which is the method of any of the first through the seventh embodiments, wherein the generally horizontal second wellbore is located generally parallel to a wellbore axis of the curved wellbore with a sinusoidal wellbore path in a vertical plane.

A ninth embodiment, which is the method of any of the first through the eight embodiments, wherein the curved wellbore path with a sinusoidal wellbore path in a vertical plane is drilled along or generally coincident to a fracture plane of the subterranean formation.

A tenth embodiment, which is the method of any of the first through the ninth embodiments, wherein the generally horizontal second wellbore is located generally coincident to a wellbore axis of the curved wellbore path with a helical wellbore path.

A eleventh embodiment, which is the method of any of the first through the tenth embodiments, further comprising: a third wellbore comprising a generally horizontal wellbore penetrating the subterranean formation from a third wellhead at the surface location, and wherein the third wellbore is fluidically coupled to the first wellbore via the fractured volume.

A twelfth embodiment, which is the method of any of the first through the eleventh embodiments, wherein the generally horizontal third wellbore is located below the curved wellbore path of the first wellbore.

A thirteenth embodiment, which is the method of any of the first through the twelfth embodiments, wherein the proppant comprises a material that is i) porous or ii) coated with a second material; wherein the second material comprises i) metal hydride or ii) metal-organic frameworks (MOF); wherein the metal hydrides comprise an alloy of palladium, magnesium, aluminum, or combinations thereof, and wherein the MOFs comprise microporous organometallic framework compounds, microporous crystalline aluminosilicates, microscopically small carbon nanotubes, copper, zinc, chromium, or combinations thereof.

A fourteenth embodiment, which is the method of any of the first through the thirteenth embodiments, wherein the non-permeable formation comprises a permeability value of less than 3 microdarcy.

A fifteenth embodiment, which is the method of any of the first through the fourteenth embodiments, wherein the gas source system is further configured to: (i) generate a volume of hydrogen gas; (ii) compress the volume of hydrogen gas into a compressed gas; and deliver the compressed gas to the first wellhead.

A sixteenth embodiment, which is the method of any of the first through the fifteenth embodiments, wherein the system further comprises a gas retrieval system configured to: (i) retrieve a volume of hydrogen gas from the fractured volume of the subterranean formation; and (ii) generate electrical power from the produced hydrogen gas.

A seventeenth embodiment, which is the method of any of the first through the sixteenth embodiments, wherein the volume of hydrogen gas is retrieved via the first wellbore.

An eighteenth embodiment, which is the method of any of the first through the seventeenth embodiments, wherein the volume of hydrogen gas is retrieved via a second wellbore.

An nineteenth embodiment, which is the method of any of the first through the eighteenth embodiments, wherein the volume of hydrogen gas is retrieved via a third wellbore.

A twentieth embodiment, which is a method of designing a subterranean gas storage system, comprising: (i) determining a fracture area of a first well by inputting a first wellbore geometry for the first well, a set of geomechanical data for a subterranean formation, a first fracturing operation, or combinations thereof into a fracture model, wherein the first wellbore geometry comprises i) a sinusoidal path in a horizontal plane, ii) a sinusoidal path in a vertical plane, or iii) a helical path along a wellbore axis; (ii) determining a volumetric capacity of the formation; (iii) comparing a conductive fracture flowrate from the volumetric capacity of the formation via the fracture area of the first wellbore geometry to an energy generating capacity of a power station; iteratively returning to the fracturing model to adjust the first wellbore geometry, the first fracturing operation, or both in response to the conductive fracture flowrate of a production fluid being lower than a threshold value; and outputting an injection wellbore geometry, a production wellbore geometry, a first working fracturing operation, a second working fracturing operation, or combinations thereof, in response to the volumetric capacity value and conductive fracture flowrate being higher than a threshold value.

An twenty-first embodiment, which is the method of any of the twentieth embodiments, wherein the set of geomechanical data comprises formation composition, porosity, depth, temperature, fracture plane orientation, or combinations thereof.

A twenty-second embodiment, which is the method of any of the twentieth through the twenty-first embodiments, wherein the subterranean formation is a non-permeable formation.

A twenty-third embodiment, which is the method of any of the twentieth through the twenty-second embodiments, wherein the first wellbore geometry further comprises a borehole, a casing string, a cement sheath, or combinations thereof.

A twenty-fourth embodiment, which is the method of any of the twentieth through the twenty-third embodiments, wherein the first fracturing operation comprises a completion operation configured to open a plurality of initiation points in the first wellbore geometry.

A twenty-fifth embodiment, which is the method of any of the twentieth through the twenty-fourth embodiments, wherein the first fracturing operation comprises pumping a fracturing fluid according to a pumping schedule into the first wellbore geometry of the first well.

A twenty-sixth embodiment, which is the method of any of the twentieth through the twenty-fifth embodiments, wherein the pumping schedule of the first fracturing operation comprises a plurality of fracturing stages; wherein at least one fracture from a first fracturing stage interferes with at least one fracture from a second fracture stage; and wherein the interference with the at least one fracture from the first fracturing stage increases the fracture area of the at least one fracture from the second fracturing stage.

A twenty-seventh embodiment, which is the method of any of the twentieth through the twenty-sixth embodiments, wherein the fracture area is determined by modeling a plurality of fractures extending from a plurality of initiation points in the first wellbore geometry into the subterranean formation via the first fracturing operation.

A twenty-eighth embodiment, which is the method of any of the twentieth through the twenty-fourth embodiments, further comprising determining a production area of a second well by inputting a second wellbore geometry for the second well, a second fracturing operation, or combinations thereof into the fracture model.

A twenty-ninth embodiment, which is the method of any of the twentieth through the twenty-eighth embodiments, wherein the second wellbore geometry comprises a generally horizontal wellbore path.

A thirtieth embodiment, which is the method of any of the twentieth through the twenty-ninth embodiments, wherein the generally horizontal wellbore path is i) located outside of a plurality of fracture stresses of the first fracturing operation, or ii) located within the plurality of fracture stresses of the first fracturing operation.

A thirty-first embodiment, which is the method of any of the twentieth through the thirtieth embodiments, wherein the second fracturing operation comprises a second completion operation, a second pumping operation, or combinations thereof, wherein a second completion operation comprises i) installing a filter media, ii) opening a plurality of initiation points, or iii) combinations thereof in the second wellbore geometry; and wherein the second pumping operation comprises pumping a fracturing fluid according to a pumping schedule into the second wellbore geometry of the production well.

A thirty-second embodiment, which is a method of designing a gas storage well in a non-permeable subterranean formation, comprising determining a design fractured volume of the gas storage well by inputting a design wellbore, a set of geomechanical data for a subterranean formation, a design fracturing operation, or combinations thereof into a fracture model, wherein the design wellbore comprises a design wellbore path and a design wellbore geometry, wherein the design wellbore path comprises i) a sinusoidal path in a horizontal plane, ii) a sinusoidal path in a vertical plane, or iii) a helical path along a wellbore axis; and iterating the design fractured volume of the design well by modifying the design wellbore path, the design fracturing operation, or combinations thereof in response to a volumetric capacity of the fractured volume of the non-permeable subterranean formation being below a threshold value.

A thirty-third embodiment, which is the method of the thirty-second embodiment, further comprises determining a fractured production area of a second wellbore by inputting a second wellbore geometry, a second wellbore path, a second fracturing operation, or combinations thereof into a fracture model.

A thirty-fourth embodiment, which is the method of any of the thirty-second embodiment through the thirty-third embodiments, further comprises determining a conductive fracture flowrate through the design fracture volume of the design wellbore to the second wellbore by inputting a flowrate of an injection fluid into a production model.

A thirty-fifth embodiment, which is the method of any of the thirty-second embodiment through the thirty-fourth embodiments, further comprises determining a generating capacity of a power station to consume the production fluid.

A thirty-sixth embodiment, which is the method of any of the thirty-second embodiment through the thirty-fifth embodiments, further comprises generating a working wellbore path and a working fracturing operation in response to the generating capacity of the power station being below a threshold value.

A thirty-seventh embodiment, wherein hydrogen is produced in subterranean fractures in accordance with any of the embodiments disclosed in co-pending U.S. patent application______[Attorney Docket Number 2023-INV-111856-US01 (4727-55400)], filed concurrently herewith and incorporated by reference herein in its entirety, and the hydrogen produced underground is then stored in a subterranean gas storage system in accordance with any of the preceding embodiments one to thirty-six.

A thirty-eighth embodiment, wherein the fractured volume and/or fracture area of the subterranean formation (e.g., a complex fracture network) of any of the preceding embodiments is formed in accordance with any of the embodiments disclosed in co-pending U.S. patent application Ser. No. 18/210,211 entitled Optimizing Well Placement to Maximize Exposed Hydraulic Fracture Area in Geothermal Wells, incorporated by reference herein in its entirety.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R1, and an upper limit, Ru, is disclosed, any number falling within the range is specifically disclosed. In particular, the following numbers within the range are specifically disclosed: R=R1+k* (Ru−R1), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference herein is not an admission that it is prior art, especially any reference that may have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A system for storing gas within a subterranean formation, comprising:
a first wellbore comprising a curved wellbore path extending into the subterranean formation from a first wellhead at a surface location;
a fractured volume of the subterranean formation comprising a volume of proppant within a fracture network, wherein the fracture network is in response to a fracturing operation, wherein a volume of proppant is enhanced by the curved wellbore path, and wherein the subterranean formation is a non-permeable formation;
a gas source fluidically coupled to the first wellhead and configured to pump a compressed gas into the fractured volume via the first wellbore; and
wherein the fractured volume within the non-permeable formation is configured to store the compressed gas.

2. The system of claim 1, wherein the curved wellbore path of the first wellbore comprises a sinusoidal wellbore path with a vertical portion coupled to the first wellhead.

3. The system of claim 1, wherein the curved wellbore of the first wellbore comprises a helical wellbore path with a vertical portion coupled to the first wellhead.

4. The system of claim 3, wherein the curved wellbore path with the helical wellbore path is drilled along or generally coincident to a fracture plane of the subterranean formation.

5. The system of claim 1, further comprising:
a second wellbore comprising a generally horizontal wellbore penetrating the subterranean formation from a second wellhead at the surface location, and wherein the second wellbore is fluidically coupled to the first wellbore via the fractured volume.

6. The system of claim 5, wherein the generally horizontal wellbore of the second wellbore is located i) above or ii) below the curved wellbore with a sinusoidal wellbore path in a horizontal plane.

7. The system of claim 5, wherein the curved wellbore with a sinusoidal wellbore path in a horizontal plane is drilled perpendicular to a fracture plane of the subterranean formation.

8. The system of claim 5, wherein the generally horizontal second wellbore is located generally parallel to a wellbore axis of the curved wellbore with a sinusoidal wellbore path in a vertical plane.

9. The system of claim 8, wherein the curved wellbore path with a sinusoidal wellbore path in a vertical plane is drilled along or generally coincident to a fracture plane of the subterranean formation.

10. The system of claim 5, wherein the generally horizontal second wellbore is located generally coincident to a wellbore axis of the curved wellbore path with a helical wellbore path.

11. The system of claim 5, further comprising:
a third wellbore comprising a generally horizontal wellbore penetrating the subterranean formation from a third wellhead at the surface location, and wherein the third wellbore is fluidically coupled to the first wellbore via the fractured volume.

12. The system of claim 11, wherein the generally horizontal third wellbore is located below the curved wellbore path of the first wellbore.

13. The system of claim 1, wherein:
the proppant comprises a material that is i) porous or ii) coated with a second material;
wherein the second material comprises i) metal hydride or ii) metal-organic frameworks (MOF);
wherein the metal hydrides comprise an alloy of palladium, magnesium, aluminum, or combinations thereof; and
wherein the MOFs comprise microporous organometallic framework compounds, microporous crystalline aluminosilicates, microscopically small carbon nanotubes, copper, zinc, chromium, or combinations thereof.

14. The system of claim 1, wherein the non-permeable formation comprises a permeability value of less than 3 microdarcy.

15. The system of claim 1, wherein the gas source is further configured to:
(i) generate a volume of hydrogen gas;
(ii) compress the volume of hydrogen gas into a compressed gas; and
deliver the compressed gas to the first wellhead.

16. The system of claim 1, wherein the system further comprises a gas retrieval system configured to:
(i) retrieve a volume of hydrogen gas from the fractured volume of the subterranean formation; and
(ii) generate electrical power from the retrieved hydrogen gas.

17. The system of claim 16, wherein the volume of hydrogen gas is retrieved via the first wellbore, via a second wellbore, via a third wellbore, or any combination thereof.

18. A method of designing a subterranean gas storage system, comprising:
(i) determining a fracture area of a first well by inputting a first wellbore geometry for the first well, a set of geomechanical data for a subterranean formation, a first fracturing operation, or combinations thereof into a fracture model, wherein the first wellbore geometry comprises i) a sinusoidal path in a horizontal plane, ii) a sinusoidal path in a vertical plane, or iii) a helical path along a wellbore axis;
(ii) determining a volumetric capacity of the formation;
(iii) comparing a conductive fracture flowrate from the volumetric capacity of the formation via the fracture area of the first wellbore geometry to an energy generating capacity of a power station;
iteratively returning to the fracturing model to adjust the first wellbore geometry, the first fracturing operation, or both in response to the conductive fracture flowrate of a production fluid being lower than a threshold value; and
outputting an injection wellbore geometry, a production wellbore geometry, a first working fracturing operation, a second working fracturing operation, or combinations thereof, in response to the volumetric capacity value and conductive fracture flowrate being higher than a threshold value.

19. The method of claim 18, wherein the subterranean formation is a non-permeable formation.

20. A method of designing a gas storage well in a non-permeable subterranean formation, comprising:
determining a design fractured volume of the gas storage well by inputting a design wellbore, a set of geomechanical data for a subterranean formation, a design fracturing operation, or combinations thereof into a fracture model, wherein the design wellbore comprises a design wellbore path and a design wellbore geometry, wherein the design wellbore path comprises i) a sinusoidal path in a horizontal plane, ii) a sinusoidal path in a vertical plane, or iii) a helical path along a wellbore axis; and
iterating the design fractured volume of the design well by modifying the design wellbore path, the design fracturing operation, or combinations thereof in response to a volumetric capacity of the fractured volume of the non-permeable subterranean formation being below a threshold value.
